(19) United States
(12) Patent Application Publication
(10) Pub. No.: US 2020/0213340 A1
(43) Pub. Date: Jul. 2, 2020

(54) DETECTOR, DETECTION METHOD AND DETECTION PROGRAM

(71) Applicants: Sumitomo Electric Industries, Ltd., Osaka-shi (JP); Sumitomo Wiring Systems, Ltd., Yokkaichi (JP); AutoNetworks Technologies, Ltd., Yokkaichi (JP)

(72) Inventor: Yoshihiro HAMADA, Osaka-shi (JP)

(73) Assignees: Sumitomo Electric Industries, Ltd., Osaka-shi (JP); Sumitomo Wiring Systems, Ltd., Yokkaichi (JP); AutoNetworks Technologies, Ltd., Yokkaichi (JP)

(21) Appl. No.: 16/633,008

(22) PCT Filed: Apr. 11, 2018
(86) PCT No.: PCT/JP2018/015212

§ 371 Date: Jan. 22, 2020

(30) Foreign Application Priority Data
Aug. 3, 2017 (JP) 2017-150807

(51) Int. Cl. H04L 29/06; H04L 12/40; B60R 16/023

(52) U.S. Cl. CPC H04L 63/1425; H04L 12/40; H04L 2012/40273; H04L 63/12; H04L 2012/40215; B60R 16/023

(57) ABSTRACT

This detection device is configured to detect an unauthorized message in an on-vehicle network mounted in a vehicle, and includes: a message acquisition unit configured to acquire one or a plurality of transmission messages in the on-vehicle network; a data acquisition unit configured to acquire a set of a plurality of types of data that are included in the transmission messages acquired by the message acquisition unit and that correspond to the same time; a storage unit configured to store a detection condition, the detection condition being created in advance and based on a plurality of the sets that respectively correspond to a plurality of times; and a detection unit configured to detect the unauthorized message on the basis of the set acquired by the data acquisition unit and the detection condition.

### TECHNICAL FIELD

The present invention relates to a detection device, a detection method, and a detection program. This application claims priority on Japanese Patent Application No. 2017-150807 filed on Aug. 3, 2017, the entire content of which is incorporated herein by reference.

### BACKGROUND ART

PATENT LITERATURE 1 (Japanese Laid-Open Patent Publication No. 2016-116075) discloses the following on-vehicle communication system. That is, the on-vehicle communication system is an on-vehicle communication system that performs message authentication by use of: a transmitter code that is a message authentication code generated by a transmitter of communication data; and a receiver code that is a message authentication code generated by a receiver of the communication data, the on-vehicle communication system comprising: a first ECU connected to an on-vehicle network and having only a first encryption key among the first encryption key and a second encryption key different from the first encryption key; a second ECU connected to the on-vehicle network and having at least the first encryption key; and a third ECU connected to the on-vehicle network and an external network and having only the second encryption key among the first encryption key and the second encryption key, the third ECU being configured to generate the transmitter code or the receiver code by use of the second encryption key when communicating over the on-vehicle network, wherein the second ECU transmits communication data to which the transmitter code generated by use of the first encryption key is assigned, and the first ECU verifies, when receiving the communication data, the transmitter code assigned to the received communication data by using the receiver code generated by use of the first encryption key.

### CITATION LIST

### Patent Literature

PATENT LITERATURE 1: Japanese Laid-Open Patent Publication No. 2016-116075

PATENT LITERATURE 2: Japanese Laid-Open Patent Publication No. 2016-57438

PATENT LITERATURE 3: Japanese Laid-Open Patent Publication No. 2016-97879

PATENT LITERATURE 4: Japanese Laid-Open Patent Publication No. 2015-136107

### SUMMARY OF INVENTION

### Solution to Problem

(1) A detection device of the present disclosure is configured to detect an unauthorized message in an on-vehicle network mounted in a vehicle. The detection device includes: a message acquisition unit configured to acquire one or a plurality of transmission messages in the on-vehicle network; a data acquisition unit configured to acquire a set of a plurality of types of data that are included in the transmission messages acquired by the message acquisition unit and that correspond to the same time; a storage unit configured to store a detection condition, the detection condition being created in advance and based on a plurality of the sets that respectively correspond to a plurality of times; and a detection unit configured to detect the unauthorized message on the basis of the set acquired by the data acquisition unit and the detection condition.

(11) A detection method of the present disclosure is to be performed in a detection device including a storage unit and configured to detect an unauthorized message in an on-vehicle network mounted in a vehicle. The detection method includes: a step of acquiring one or a plurality of transmission messages in the on-vehicle network; and a step of acquiring a set of a plurality of types of data that are included in the acquired transmission messages and that correspond to the same time. The storage unit stores a detection condition created in advance and based on a plurality of the sets that respectively correspond to a plurality of times. The detection method further includes a step of detecting the unauthorized message on the basis of the acquired set and the detection condition.

(12) A detection program of the present disclosure is to be used in a detection device, the detection device including a storage unit and configured to detect an unauthorized message in an on-vehicle network mounted in a vehicle. The detection program is configured to cause a computer to function as: a message acquisition unit configured to acquire one or a plurality of transmission messages in the on-vehicle network; and a data acquisition unit configured to acquire a set of a plurality of types of data that are included in the transmission messages acquired by the message acquisition unit and that correspond to the same time. The storage unit stores a detection condition created in advance and based on a plurality of the sets that respectively correspond to a plurality of times. The detection program further causes the computer to function as a detection unit configured to detect the unauthorized message on the basis of the set acquired by the data acquisition unit and the detection condition.

One mode of the present disclosure can be realized not only as a detection device including such a characteristic processing unit but also as an on-vehicle communication system including the detection device. One mode of the present disclosure can be realized as a semiconductor integrated circuit that realizes a part or the entirety of the detection device.

### BRIEF DESCRIPTION OF DRAWINGS

FIG. 1 shows a configuration of an on-vehicle communication system according to a first embodiment of the present disclosure.

FIG. 2 shows a configuration of a bus connection device group according to the first embodiment of the present disclosure.

FIG. 3 shows a configuration of a gateway device in the on-vehicle communication system according to the first embodiment of the present disclosure.

FIG. 4 is a diagram for describing a creation process of a normal model to be used by the gateway device according to the first embodiment of the present disclosure.

FIG. 5 is a diagram for describing timings at which a synchronization process is performed in the gateway device according to the first embodiment of the present disclosure.

FIG. 6 is a diagram for describing timings at which a synchronization process is performed in the gateway device according to the first embodiment of the present disclosure.

FIG. 7 is a diagram for describing detection of an unauthorized message performed by a detection unit in the gateway device according to the first embodiment of the present disclosure.

FIG. 8 is a diagram for describing effects of the on-vehicle communication system according to the first embodiment of the present disclosure.

FIG. 9 is a diagram for describing effects of the on-vehicle communication system according to the first embodiment of the present disclosure.

FIG. 10 is a diagram for describing a creation process in a learning phase with respect to a modification of the normal model according to the first embodiment of the present disclosure.

FIG. 11 is a diagram for describing a verification process in a test phase with respect to a modification of the normal model according to the first embodiment of the present disclosure.

FIG. 12 is a diagram for describing a detection process for an unauthorized message, using a modification of the normal model according to the first embodiment of the present disclosure.

FIG. 13 is a diagram for describing a creation process in a learning phase with respect to a modification of the normal model according to the first embodiment of the present disclosure.

FIG. 14 is a diagram for describing a detection process for an unauthorized message, using a modification of the normal model according to the first embodiment of the present disclosure.

FIG. 15 is a flow chart of a procedure of operation performed when the gateway device according to the first embodiment of the present disclosure receives a message.

FIG. 16 is a flow chart of a procedure of operation performed when the gateway device according to the first embodiment of the present disclosure has stored a received message into a storage unit.

FIG. 17 is a diagram for describing one example of erroneous detection in a gateway device according to a second embodiment of the present disclosure.

FIG. 18 shows a configuration of a gateway device in the on-vehicle communication system according to the second embodiment of the present disclosure.

FIG. 19 is a diagram for describing update of a normal model performed by an update unit in the gateway device according to the second embodiment of the present disclosure.

FIG. 20 is a diagram for describing a normal model updated by the update unit in the gateway device according to the second embodiment of the present disclosure.

FIG. 21 shows a configuration of a gateway device in the on-vehicle communication system according to a third embodiment of the present disclosure.

FIG. 22 shows one example of temporal change in a transmission interval of a periodic message to be monitored in the on-vehicle communication system according to the third embodiment of the present disclosure.

FIG. 23 shows one example of a frequency distribution of target message transmission interval in the on-vehicle communication system according to the third embodiment of the present disclosure.

FIG. 24 shows an example of unauthorized message detection performed by the detection unit in the gateway device according to the third embodiment of the present disclosure.

FIG. 25 is a flow chart of a procedure of operation performed when the gateway device according to the third embodiment of the present disclosure receives a target message.

FIG. 26 is a flow chart of a procedure of operation performed when the gateway device according to the third embodiment of the present disclosure performs a determination process.

### DESCRIPTION OF EMBODIMENTS

To date, on-vehicle network systems for improving security in on-vehicle networks have been developed.

[Problem to be Solved by the Present Disclosure]

PATENT LITERATURE 1 discloses a configuration in which a first encryption key to be used in message authentication by a first ECU and a second ECU which are connected only to an on-vehicle network is different from a second encryption key to be used by a third ECU connected to both the on-vehicle network and an external network, thereby preventing cyberattack from the external network on the first ECU and the second ECU which are not connected to the external network.

However, in a case of a security measure that uses message authentication, the security measure could be invalidated by an attack on vulnerability of a protocol, an attack using the first encryption key illegally obtained, an attack on an obsolete encryption algorithm, or the like.

In a case where such an attack has been made, a technology for properly detecting intrusion of an attacker into the on-vehicle network is required.

The present disclosure has been made in order to solve the above-described problem. An object of the present disclosure is to provide a detection device, a detection method, and a detection program that can properly detect an unauthorized message in an on-vehicle network.

[Effect of the Present Disclosure]

According to the present disclosure, an unauthorized message in an on-vehicle network can be properly detected.

[Description of Embodiment of the Present Disclosure]

First, contents of embodiments of the present disclosure are listed and described.

(1) A detection device according to an embodiment of the present disclosure is configured to detect an unauthorized message in an on-vehicle network mounted in a vehicle. The detection device includes: a message acquisition unit configured to acquire one or a plurality of transmission messages in the on-vehicle network; a data acquisition unit configured to acquire a set of a plurality of types of data that are included in the transmission messages acquired by the message acquisition unit and that correspond to the same time; a storage unit configured to store a detection condition, the detection condition being created in advance and based on a plurality of the sets that respectively correspond to a plurality of times; and a detection unit configured to detect the unauthorized message on the basis of the set acquired by the data acquisition unit and the detection condition.

For example, in a case where there is a certain relationship between a plurality of types of data, if the relationship is used, it is possible to calculate, from certain data, a range of the values that another data can take. Due to the above configuration, for example, from the certain data in the above set, a range of the values that the other data in the set can take can be calculated on the basis of the detection condition. Thus, the authenticity of the other data can be properly determined. Accordingly, a message that includes data determined as unauthorized can be detected as an unauthorized message. Therefore, an unauthorized message in the on-vehicle network can be properly detected.

(2) Preferably, the detection condition is created on the basis of the sets of a plurality of types of data that have a predetermined correlation.

Due to the configuration in which a detection condition is created on the basis of sets of a plurality of types of data between which some relationship exists, it is possible to create a detection condition that allows, on the basis of certain data in a set, reduction of the range of the values that another data in the set can take. Accordingly, the authenticity of the other data can be more properly determined. That is, an appropriate detection condition can be created.

(3) More preferably, when there are a plurality of types of correlation data that are the data having the correlation with a certain type of the data, the single detection condition is created on the basis of the certain type of the data and the plurality of types of the correlation data.

Due to this configuration, for example, even when an attacker has modified part of data in the certain type of data and the plurality of types of correlation data, it is possible to determine an abnormality of data in the above set, on the basis of the relationship between the modified data and the residual data. That is, in order to make illegal intrusion, the attacker has to modify all of the certain type of data and the plurality of types of correlation data. Thus, illegal intrusion into the on-vehicle network can be made difficult. Accordingly, security in the on-vehicle network can be improved.

(4) More preferably, the detection unit calculates an estimated error of the certain type of the data on the basis of the certain type of the data and the plurality of types of the correlation data acquired by the data acquisition unit and the detection condition, evaluates authenticity of the certain type of the data on the basis of the calculated estimated error and a distribution of the estimated error created by use of the detection condition, and determines whether or not the certain type of the data is the unauthorized message, on the basis of a result of the evaluation.

Due to this configuration, for example, in a case where a certain type of data is composed of a value that continuously varies such as a value measured by a sensor, the possibility that the certain type of data has a proper value can be more accurately evaluated. Therefore, the authenticity of the certain type of data can be more properly determined.

(5) More preferably, the certain type of the data is data that indicates a state, and the detection unit estimates a value of the certain type of the data on the basis of the plurality of types of the correlation data acquired by the data acquisition unit and the detection condition, and determines whether or not the certain type of the data corresponds to the unauthorized message, on the basis of a result of comparison between the estimated value and the certain type of the data.

Due to this configuration, for example, in case where a certain type of data is composed of a value that discontinuously varies in such a case of a gear shift position or a seat belt state, a value that the certain type of data should indicate can be more properly estimated. Thus, the authenticity of the certain type of data can be more properly determined.

(6) More preferably, when there are a plurality of types of correlation data that are the data having the correlation with a certain type of the data, a plurality of the detection conditions are created on the basis of the certain type of the data and the plurality of types of the correlation data, respectively.

Due to this configuration, illegal intrusion into the on-vehicle network can be made difficult, and the calculation load in calculation of the detection condition can be reduced.

(7) Preferably, the data acquisition unit acquires a set of the plurality of types of data respectively included in the transmission messages that are different from each other.

A plurality of types of data whose reception times, transmission times, creation times, or the like are different from each other are respectively included in different transmission messages in many cases. Due to the above configuration, the types of data to be detected can be prevented from being restricted because of time.

(8) More preferably, the message acquisition unit stores, into the storage unit, a plurality of the transmission messages having been acquired, and the data acquisition unit acquires the set from the transmission messages stored in the storage unit.

Due to this configuration, for example, data in the plurality of transmission messages stored in the storage unit can be resampled, and thus, the times of a plurality of types of data can be adjusted to the same time. Accordingly, a set of a plurality of types of data corresponding to the same time can be easily acquired.

(9) Preferably, the detection device further includes an update unit configured to update the detection condition on the basis of the set acquired by the data acquisition unit.

Due to this configuration, for example, even if the sets used in calculation of the detection condition are not perfect as a population, a newly acquired set can be included in the population. Thus, the degree of perfection of the population can be more enhanced. Accordingly, the detection condition can be updated to a more appropriate detection condition.

(10) Preferably, the detection device further includes a monitor unit configured to monitor the transmission messages in the on-vehicle network, and a distribution acquisition unit configured to acquire a distribution of transmission intervals of the transmission messages. The detection unit detects the unauthorized message on the basis of a monitoring result by the monitor unit and the distribution acquired by the distribution acquisition unit. With respect to a transmission message that has been determined as not to be classified as the unauthorized message, the detection unit determines whether or not the transmission message is the unauthorized message, on the basis of the set acquired by the data acquisition unit and the detection condition.

A transmission message that has a pseudo transmission interval accurately adjusted is difficult to be detected as an unauthorized message on the basis of the monitoring result and the distribution described above. Due to the above configuration, such a transmission message can be detected as an unauthorized message on the basis of the set and the detection condition described above. Therefore, security in the on-vehicle network can be improved.

(11) A detection method according to an embodiment of the present disclosure is to be performed in a detection device including a storage unit and configured to detect an unauthorized message in an on-vehicle network mounted in a vehicle. The detection method includes: a step of acquiring one or a plurality of transmission messages in the on-vehicle network; and a step of acquiring a set of a plurality of types of data that are included in the acquired transmission messages and that correspond to the same time. The storage unit stores a detection condition created in advance and based on a plurality of the sets that respectively correspond to a plurality of times. The detection method further includes a step of detecting the unauthorized message on the basis of the acquired set and the detection condition.

For example, in a case where there is a certain relationship between a plurality of types of data, if the relationship is used, it is possible to calculate, from certain data, a range of the values that another data can take. Due to the above configuration, for example, from the certain data in the above set, a range of the values that the other data in the set can take can be calculated on the basis of the detection condition. Thus, the authenticity of the other data can be properly determined. Accordingly, a message that includes data determined as unauthorized can be detected as an unauthorized message. Therefore, an unauthorized message in the on-vehicle network can be properly detected.

(12) A detection program according to an embodiment of the present disclosure is to be used in a detection device, the detection device including a storage unit and configured to detect an unauthorized message in an on-vehicle network mounted in a vehicle. The detection program is configured to cause a computer to function as: a message acquisition unit configured to acquire one or a plurality of transmission messages in the on-vehicle network; and a data acquisition unit configured to acquire a set of a plurality of types of data that are included in the transmission messages acquired by the message acquisition unit and that correspond to the same time. The storage unit stores a detection condition created in advance and based on a plurality of the sets that respectively correspond to a plurality of times. The detection program further causes the computer to function as a detection unit configured to detect the unauthorized message on the basis of the set acquired by the data acquisition unit and the detection condition.

For example, in a case where there is a certain relationship between a plurality of types of data, if the relationship is used, it is possible to calculate, from certain data, a range of the values that another data can take. Due to the above configuration, for example, from the certain data in the above set, a range of the values that the other data in the set can take can be calculated on the basis of the detection condition. Thus, the authenticity of the other data can be properly determined. Accordingly, a message that includes data determined as unauthorized can be detected as an unauthorized message. Therefore, an unauthorized message in the on-vehicle network can be properly detected.

Hereinafter, embodiments of the present disclosure will be described with reference to the drawings. In the drawings, the same or corresponding parts are denoted by the same reference signs, and descriptions thereof are not repeated. At least some parts of the embodiments described below can be combined together as desired.

### First Embodiment

[Configuration and Basic Operation]

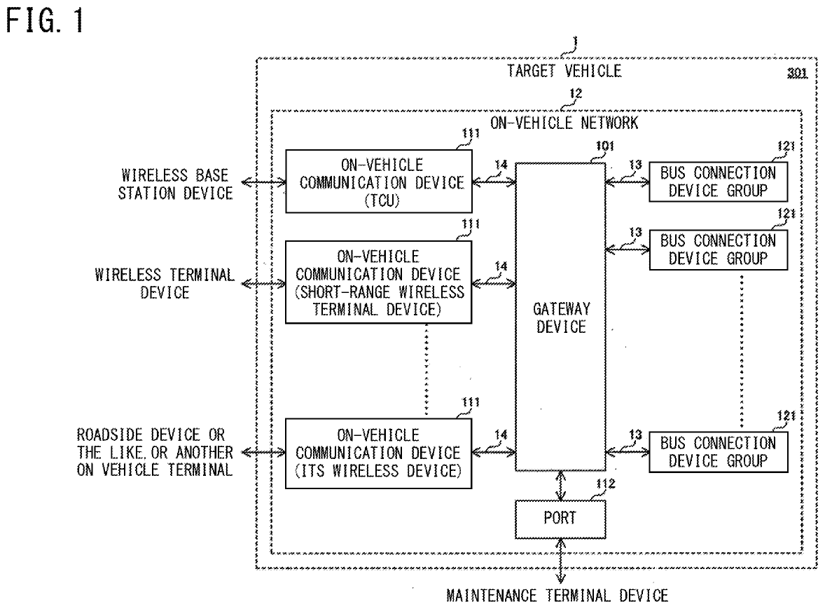

FIG. 1 shows a configuration of an on-vehicle communication system according to a first embodiment of the present disclosure.

With reference to FIG. 1, an on-vehicle communication system 301 includes a gateway device (detection device) 101, a plurality of on-vehicle communication devices 111, and a plurality of bus connection device groups 121.

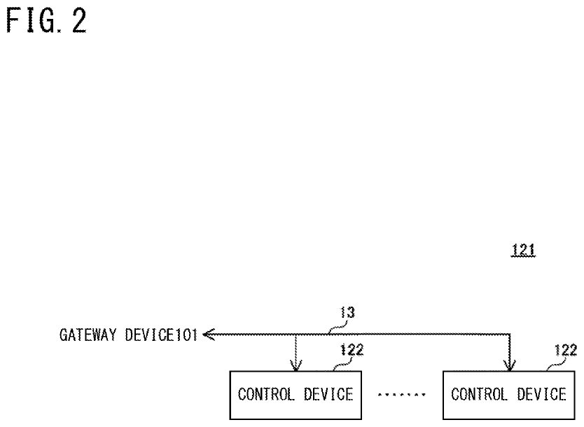

FIG. 2 shows a configuration of a bus connection device group according to the first embodiment of the present disclosure.

With reference to FIG. 2, the bus connection device group 121 includes a plurality of control devices 122. The bus connection device group 121 need not necessarily include a plurality of control devices 122, and may include one control device 122.

The on-vehicle communication system 301 is mounted in a vehicle (hereinafter, also referred to as target vehicle) 1 which travels on a road. An on-vehicle network 12 includes a plurality of on-vehicle devices which are each a device provided in the target vehicle 1. Specifically, the on-vehicle network 12 includes a plurality of on-vehicle communication devices 111 and a plurality of control devices 122, which are examples of the on-vehicle devices.

As long as the on-vehicle network 12 includes a plurality of on-vehicle devices, the on-vehicle network 12 may be configured to include a plurality of on-vehicle communication devices 111 and not to include any control device 122, may be configured not to include any on-vehicle communication device 111 and to include a plurality of control devices 122, or may be configured to include one on-vehicle communication device 111 and one control device 122.

In the on-vehicle network 12, the on-vehicle communication device 111 communicates with a device outside the target vehicle 1, for example. Specifically, the on-vehicle communication device 111 is a TCU (Telematics Communication Unit), a short-range wireless terminal device, or an ITS (Intelligent Transport Systems) wireless device, for example.

The TCU can perform wireless communication with a wireless base station device in accordance with a communication standard such as LTE (Long Term Evolution) or 3G, and can perform communication with the gateway device 101, for example. The TCU relays information to be used in services such as navigation, vehicle burglar prevention, remote maintenance, and FOTA (Firmware Over The Air), for example.

For example, the short-range wireless terminal device can perform wireless communication with a wireless terminal device such as a smartphone held by a person (hereinafter, also referred to as occupant) in the target vehicle 1, in accordance with a communication standard such as Wi-Fi (registered trade mark) and Bluetooth (registered trade mark), and can perform communication with the gateway device 101. The short-range wireless terminal device relays information to be used in a service such as entertainment, for example.

For example, the short-range wireless terminal device can perform wireless communication with a wireless terminal device such as a smart key held by the occupant and with a wireless terminal device provided at a tire, in accordance with a predetermined communication standard by using a radio wave in an LF (Low Frequency) band or a UHF (Ultra High Frequency) band, and can perform communication with the gateway device 101. The short-range wireless terminal device relays information to be used in services such as smart entry and TPMS (Tire Pressure Monitoring System), for example.

The ITS wireless device can perform roadside-to-vehicle communication with a roadside device, such as an optical beacon, a radio wave beacon, or an ITS spot, provided in the vicinity of a road, can perform vehicle-to-vehicle communication with an on-vehicle terminal mounted in another vehicle, and can perform communication with the gateway device 101, for example. The ITS wireless device relays information to be used in services such as congestion alleviation, safe driving support, and route guidance, for example.

The gateway device 101 can, via a port 112, transmit/receive data for update or the like of firmware, and data, etc., accumulated by the gateway device 101 to/from a maintenance terminal device outside the target vehicle 1.

The gateway device 101 is connected to on-vehicle devices via buses 13, 14, for example. Specifically, each bus 13, 14 is a bus according to a standard of CAN (Controller Area Network) (registered trade mark), FlexRay (registered trade mark), MOST (Media Oriented Systems Transport) (registered trade mark), Ethernet (registered trade mark), LIN (Local Interconnect Network), or the like.

In this example, each on-vehicle communication device 111 is connected to the gateway device 101 via a corresponding bus 14 according to the Ethernet standard. Each control device 122 in each bus connection device group 121 is connected to the gateway device 101 via a corresponding bus 13 according to the CAN standard. The control device 122 can control a function section in the target vehicle 1, for example.

The buses 13 are provided for respective types of systems, for example. Specifically, the buses 13 are implemented as a drive-system bus, a chassis/safety-system bus, a body/electrical-equipment-system bus, and an AV/information-system bus, for example.

The drive-system bus has connected thereto an engine control device, an AT (Automatic Transmission) control device, and an HEV (Hybrid Electric Vehicle) control device, which are examples of the control device 122. The engine control device, the AT control device, and the HEV control device control an engine, an AT, and switching between the engine and a motor, respectively.

The chassis/safety-system bus has connected thereto a brake control device, a chassis control device, and a steering control device, which are examples of the control device 122. The brake control device, the chassis control device, and the steering control device control a brake, a chassis, and steering, respectively.

The body/electrical-equipment-system bus has connected thereto an instrument indication control device, an air conditioner control device, a burglar prevention control device, an air bag control device, and a smart entry control device, which are examples of the control device 122. The instrument indication control device, the air conditioner control device, the burglar prevention control device, the air bag control device, and the smart entry control device control instruments, an air conditioner, a burglar prevention mechanism, an air bag mechanism, and smart entry, respectively.

The AV/information-system bus has connected thereto a navigation control device, an audio control device, an ETC (Electronic Toll Collection System) (registered trade mark) control device, and a telephone control device, which are examples of the control device 122. The navigation control device, the audio control device, the ETC control device, and the telephone control device control a navigation device, an audio device, an ETC device, and a mobile phone, respectively.

The bus 13 need not necessarily have the control devices 122 connected thereto, and may have connected thereto a device other than the control devices 122, such as a sensor, for example.

The gateway device 101 is a central gateway (CGW), for example, and can perform communication with the on-vehicle devices.

The gateway device 101 performs a relay process of relaying information transmitted/received between control devices 122 that are connected to different buses 13 in the target vehicle 1, information transmitted/received between on-vehicle communication devices 111, and information transmitted/received between a control device 122 and an on-vehicle communication device 111, for example.

More specifically, in the target vehicle 1, for example, a message is periodically transmitted from an on-vehicle device to another on-vehicle device in accordance with a predetermined rule. In this example, a message that is periodically transmitted from a control device 122 to another control device 122 is described. However, the contents described below also apply to a message that is transmitted between a control device 122 and an on-vehicle communication device 111, and a message that is transmitted between on-vehicle communication devices 111.

Transmission of the message may be performed by broadcast or may be performed by unicast. Hereinafter, the message periodically transmitted will also be referred to as a periodic message.

In the target vehicle 1, other than the periodic message, a message that is non-periodically transmitted from a control device 122 to another control device 122 exists. Each message includes an ID for identifying a transmission source or the like and the content of the message. Whether or not a message is a periodic message can be discerned by the ID.

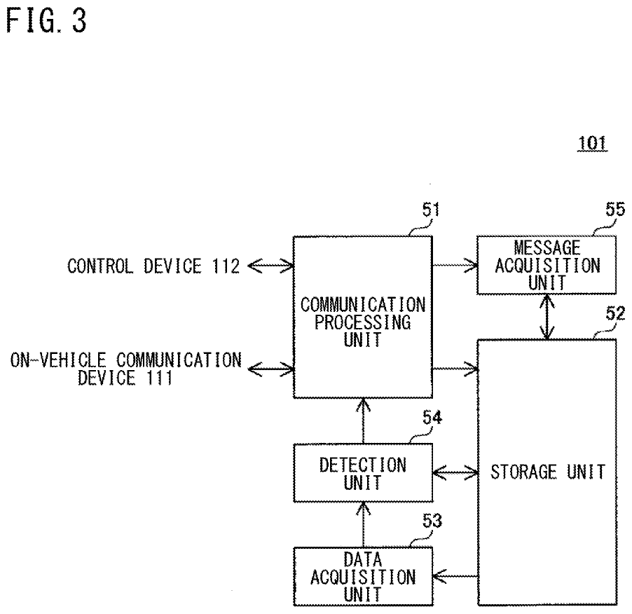

FIG. 3 shows a configuration of the gateway device in the on-vehicle communication system according to the first embodiment of the present disclosure.

With reference to FIG. 3, the gateway device 101 includes a communication processing unit 51, a storage unit 52, a data acquisition unit 53, a detection unit 54, and a message acquisition unit 55.

The gateway device 101 functions as a detection device, and detects an unauthorized message in the on-vehicle network 12 mounted in the target vehicle 1.

Specifically, the communication processing unit 51 in the gateway device 101 performs a relay process. More specifically, upon receiving a message from a control device 122 via a corresponding bus 13, the communication processing unit 51 transmits the received message to another control device 122 via a corresponding bus 13.

The message acquisition unit 55 acquires a plurality of transmission messages in the on-vehicle network 12. The message acquisition unit 55 stores the acquired plurality of transmission messages into the storage unit 52, for example.

More specifically, the storage unit 52 has registered therein detection condition information that includes the type of data to be monitored by the message acquisition unit 55, for example. Details of the detection condition information will be described later.

On the basis of the detection condition information registered in the storage unit 52, the message acquisition unit 55 recognizes the type of data to be monitored by the message acquisition unit 55.

The message acquisition unit 55 monitors data included in a message relayed by the communication processing unit 51, and performs the following process every time the message acquisition unit 55 detects a message that includes data of the type to be monitored.

That is, the message acquisition unit 55 acquires the detected message from the communication processing unit 51, and attaches, to the acquired message, a time stamp indicating the reception time of the message.

Then, the message acquisition unit 55 stores the message having the time stamp attached thereto, into the storage unit 52.

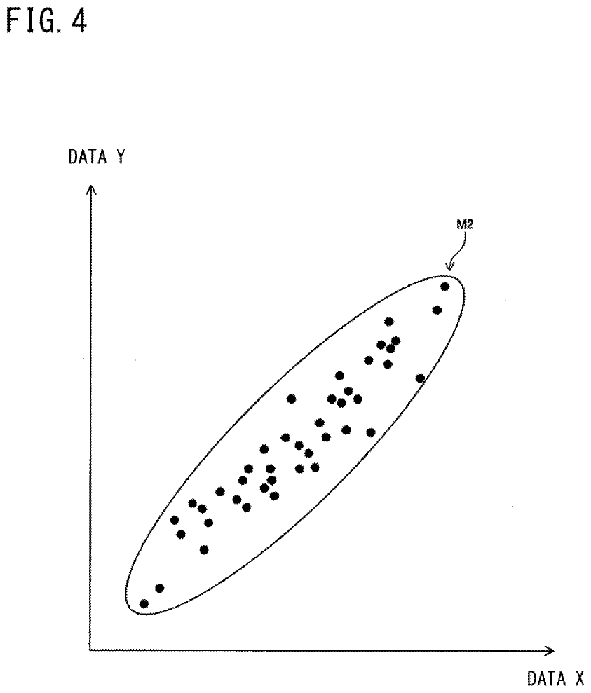

FIG. 4 is a diagram for describing a creation process of a normal model to be used by the gateway device according to the first embodiment of the present disclosure. In FIG. 4, the horizontal axis represents data X and the vertical axis represents data Y.

With reference to FIG. 4, the storage unit 52 stores a detection condition created in advance and based on a plurality of sets that respectively correspond to a plurality of times, e.g., creation times of data. Here, each set is a set of two types of data that correspond to the same creation time and that are included in the transmission messages acquired by the message acquisition unit 55, for example.

Specifically, the storage unit 52 stores a normal model M2 created in advance by a server, for example. The normal model M2 is created on the basis of sets of two types of data that have a predetermined correlation, for example.

More specifically, different types of raw data R1 to raw data RN in time series are registered in the server by a user, for example. Here, N is an integer of 2 or greater. In this example, raw data R1 to raw data RN are data acquired during development in a test vehicle of the same type as the target vehicle 1, for example.

For example, the server converts raw data R1 to raw data RN in time series into data 1 to data N at a plurality of common creation times.

More specifically, for example, when the creation times of raw data R1 and raw data R2 are not synchronized with each other, the server synchronizes the creation time of raw data R2 to the creation time of raw data R1 by resampling raw data R2.

Similarly, for example, when the creation times of raw data R1 and raw data R3 are not synchronized with each other, the server synchronizes the creation time of raw data R3 to the creation time of raw data R1 by resampling raw data R3.

By performing similar processes also on raw data R4 to raw data RN, the server synchronizes the creation times of raw data R4 to raw data RN to the creation time of raw data R1. Accordingly, raw data R1 to raw data RN in time series are converted into data 1 to data N at a plurality of common creation times.

For example, from among data 1 to data N at a plurality of common creation times, the server selects data X, Y at a plurality of common creation times. Here, X and Y are different from each other and are each an integer among 1 to N. The selection of data X, Y is performed in a round robin manner, for example.

In FIG. 4, sets of data X and data Y respectively corresponding to a plurality of common creation times are indicated by black dots.

The server calculates a correlation coefficient on the basis of a plurality of sets of the selected data X and data Y, for example.

For example, when the calculated correlation coefficient is not less than 0.4 and not greater than 0.7, the server determines that there is a correlation between the data X and the data Y. For example, when the calculated correlation coefficient is greater than 0.7, the server determines that there is a strong correlation between the data X and the data Y.

When the server has determined that there is a correlation between the data X and the data Y, or that there is a strong correlation between the data X and the data Y, the server creates a normal model M2 on the basis of the data X and the data Y.

Specifically, for example, the server creates a normal model M2 through machine learning in accordance with an algorithm such as Mahalanobis, Oneclass-SVM (Support Vector Machine), LOF (Local Outlier Factor), Isolation forest, or NN (Nearest-Neighbor).

Meanwhile, when the server has not determined that there is a correlation between the data X and the data Y, and has not determined there is a strong correlation between the data X and the data Y, the server does not create a normal model M2.

The server creates a plurality of normal models M2 and creates model information for each of the created normal models M2, for example. Here, the model information indicates a normal model M2 and a combination of corresponding types of data X and data Y.

The combination of the types of data X and data Y is, for example, engine rotation speed and speed; yaw rate and steer angle; yaw rate and vehicle height; accelerator opening and vehicle body acceleration; or the like.

The plurality of pieces of model information created by the server are collected to form detection condition information, for example, and the detection condition information is registered into the storage unit 52 during production of the target vehicle 1.

The detection condition information may be updated. Specifically, for example, the communication processing unit 51 receives, from the server via an on-vehicle communication device 111, detection condition information updated by the server, and updates the detection condition information registered in the storage unit 52 to the received detection condition information.

The server need not necessarily create a plurality of normal models M2, and may create one normal model M2.

With reference to FIG. 3 again, the data acquisition unit 53 acquires a set of two types of data that are included in the transmission messages acquired by the message acquisition unit 55 and that correspond to the same time, e.g., reception time.

More specifically, the data acquisition unit 53 acquires, from the storage unit 52, a plurality of pieces of model information included in the detection condition information stored in the storage unit 52.

[Case where Two Types of Data are Included in the Same Transmission Message]

The data acquisition unit 53 acquires a set of two types of data from each transmission message stored in the storage unit 52, for example.

More specifically, on the basis of a plurality of pieces of model information having been acquired, the data acquisition unit 53 acquires, from the storage unit 52, a set of two types of data included in the same transmission message, for example.

Specifically, for example, in a case where data corresponding to the combination of the types indicated by model information is stored in the same message and transmitted in the on-vehicle network 12, the data acquisition unit 53 acquires the two types of data from the same message stored in the storage unit 52.

For example, when a message that includes the two types of data is newly stored into the storage unit 52 by the message acquisition unit 55, the data acquisition unit 53 acquires the two types of data from the newly stored message, and outputs, to the detection unit 54, a set of the acquired two types of data and the combination of the types indicated by the model information.

[Case where Two Types of Data are Respectively Included in Different Transmission Messages]

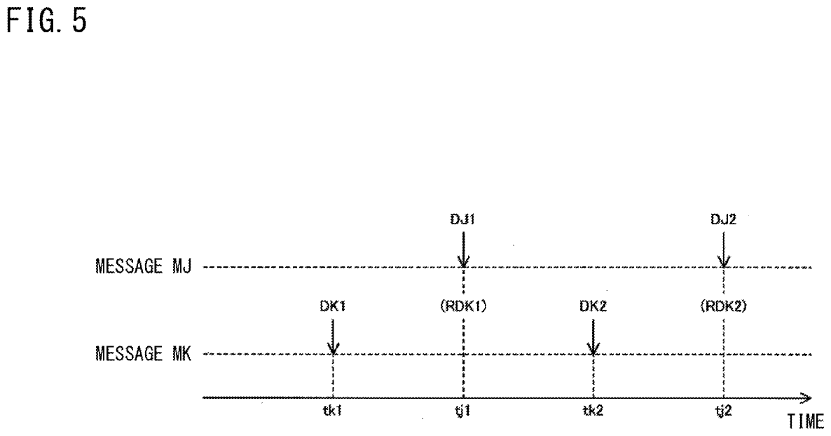

FIG. 5 is a diagram for describing timings at which a synchronization process is performed in the gateway device according to the first embodiment of the present disclosure. In FIG. 5, the horizontal axis represents time.

With reference to FIG. 5, for example, on the basis of a plurality of pieces of model information having been acquired, the data acquisition unit 53 acquires, from the storage unit 52, a set of two types of data respectively included in different transmission messages.

Specifically, for example, in a case where pieces of data corresponding to the combination of the types indicated by model information are stored in separate messages and transmitted in the on-vehicle network 12, the data acquisition unit 53 performs the following process.

That is, for example, the data acquisition unit 53 acquires, from the storage unit 52, a plurality of messages MJ that include one type of data DJ, and a plurality of messages MK that include the other type of data DK. Here, the message MJ and the message MK are messages that are transmitted in the same cycle in the on-vehicle network 12, for example.

On the basis of the time stamps attached to the plurality of messages MJ including one type of data DJ, the data acquisition unit 53 associates reception times with the one type of data DJ.

Specifically, the data acquisition unit 53 associates reception times tj1, tj2 with data DJ1, DJ2, respectively, which are examples of data DJ.

Similarly, for example, on the basis of the time stamps attached to the plurality of messages MK including the other type of data DK, the data acquisition unit 53 associates reception times with the other type of data DK.

Specifically, the data acquisition unit 53 associates reception times tk1, tk2 with data DK1, DK2, respectively, which are examples of data DK.

For example, the data acquisition unit 53 performs resampling of the other type of data DK on the basis of the reception time associated with the one type of data DJ and the reception time associated with the other type of data DK, thereby performing a synchronization process for synchronizing the reception time of the one type of data DJ and the reception time of the other type of data DK to each other.

For example, when a message MJ including the one type of data DJ is newly stored into the storage unit 52 by the message acquisition unit 55, the data acquisition unit 53 performs the synchronization process.

Specifically, for example, when a message MJ corresponding to the reception time tj2 is newly stored into the storage unit 52 by the message acquisition unit 55, the data acquisition unit 53 resamples data DK including data DK1, DK2, and the like, thereby generating resampled data RDK1, RDK2 that respectively correspond to the reception times tj1, tj2.

For example, when the synchronization process is completed, the data acquisition unit 53 acquires the newest set of the two types of data from the synchronized two types of data, and outputs, to the detection unit 54, the acquired set of the two types of data, and the combination of the types indicated by the model information.

Specifically, for example, the data acquisition unit 53 outputs, to the detection unit 54, the set of data DJ2 and the resampled data RDK2 and the combination of the types indicated by the model information.

The timing at which the data acquisition unit 53 performs the synchronization process may be a timing at which a message MK including the other type of data DK is newly stored into the storage unit 52 by the message acquisition unit 55, for example.

Specifically, for example, when a message MK corresponding to the reception time tk2 is newly stored into the storage unit 52 by the message acquisition unit 55, the data acquisition unit 53 resamples data DK including data DK1, DK2, and the like, thereby generating resampled data RDK1 that corresponds to the reception time tj1.

Then, the data acquisition unit 53 outputs, to the detection unit 54, the set of data DJ1 and the resampled data RDK1, and the combination of the types indicated by the model information, for example.

The timing at which the data acquisition unit 53 performs the synchronization process may be a timing at which both a message that includes one type of data and a message that includes the other type of data are newly stored into the storage unit 52 by the message acquisition unit 55, for example.

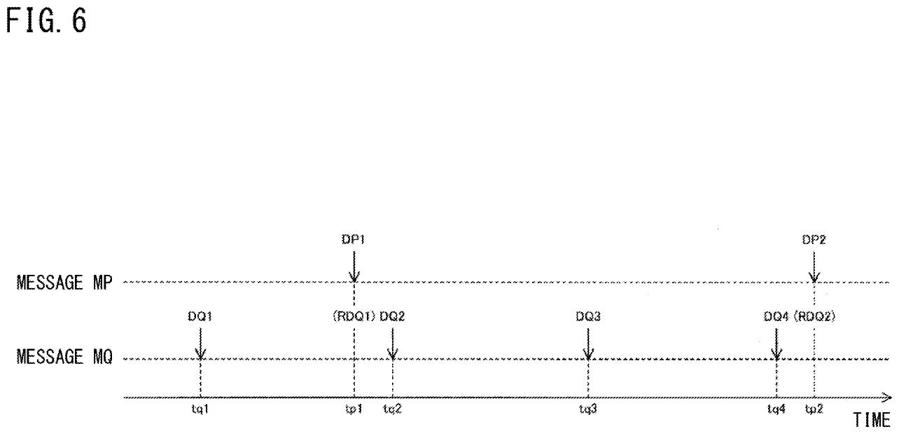

FIG. 6 is a diagram for describing timings at which a synchronization process is performed in the gateway device according to the first embodiment of the present disclosure. In FIG. 6, the horizontal axis represents time.

With reference to FIG. 6, a message MP including one type of data DP, and a message MQ including the other type of data DQ are messages that are transmitted in different cycles in the on-vehicle network 12, for example.

The data acquisition unit 53 associates reception times tp1, tp2 with data DP1, DP2, respectively, which are examples of data DP.

In addition, the data acquisition unit 53 associates reception times tq1, tq2, tq3, tq4 with data DQ1, DQ2, DQ3, DQ4, respectively, which are examples of data DQ.

When both the messages MP, MQ are newly stored into the storage unit 52 by the message acquisition unit 55, the data acquisition unit 53 performs a synchronization process, for example.

Specifically, for example, at the reception time tp1, the data acquisition unit 53 determines that both the messages MP, MQ have been newly stored into the storage unit 52 by the message acquisition unit 55, and performs the synchronization process.

Similarly, for example, at the reception time tp2, the data acquisition unit 53 determines that both the messages MP, MQ have been newly stored into the storage unit 52 by the message acquisition unit 55, and performs the synchronization process.

For example, in the synchronization process at the reception time tp2, the data acquisition unit 53 resamples data DQ including data DQ1 to DQ4, etc., thereby generating resampled data RDQ1, RDQ2 that respectively correspond to the reception times tp1, tp2.

The data acquisition unit 53 outputs, to the detection unit 54, the set of data DP2 and the resampled data RDQ2 and the combination of the types indicated by the model information, for example.

In the synchronization process at the reception time tp2, the data acquisition unit 53 may resample data DP including data DP1, DP2, etc., thereby generating resampled data RDP1 to RDP4 (not shown) that respectively correspond to the reception times tq1 to tq4.

In this case, the data acquisition unit 53 outputs, to the detection unit 54, the set of the resampled data RDP4 and data DQ4 and the combination of the types indicated by the model information.

At that time, the data acquisition unit 53 may output, to the detection unit 54, the set of the resampled data RDP2 and data DQ2, and the set of the resampled data RDP3 and data DQ3, together. Accordingly, the number of pieces of data to be used in detection of an unauthorized message can be increased.

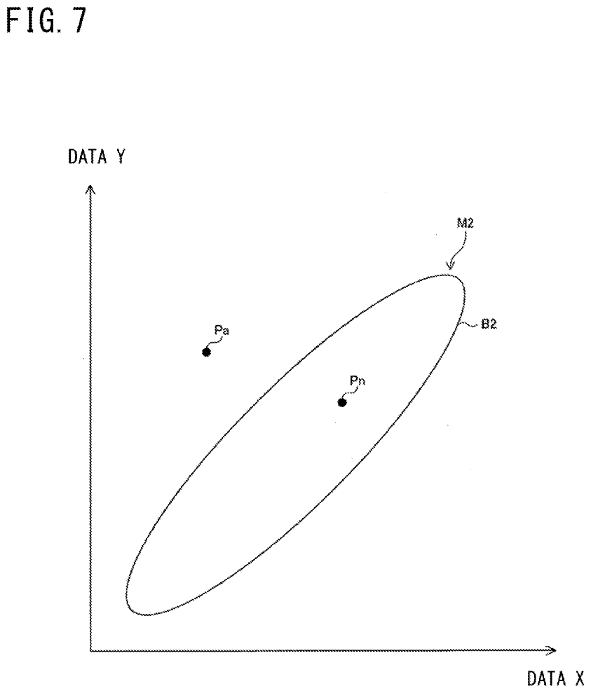

FIG. 7 is a diagram for describing detection of an unauthorized message performed by the detection unit in the gateway device according to the first embodiment of the present disclosure. The way to interpret FIG. 7 is the same as FIG. 4.

With reference to FIG. 7, on the basis of the set acquired by the data acquisition unit 53 and the detection condition, the detection unit 54 detects an unauthorized message that corresponds to the set acquired by the data acquisition unit 53.

More specifically, upon receiving the set of the two types of data from the data acquisition unit 53 and the combination of the types indicated by the model information, the detection unit 54 refers to a plurality of pieces of model information included in the detection condition information in the storage unit 52, and acquires a normal model M2 that corresponds to the received combination, from the corresponding model information in the storage unit 52.

On the basis of the set of the two types of data received from the data acquisition unit 53 and the normal model M2 acquired from the corresponding model information, the detection unit 54 detects an unauthorized message that corresponds to the set.

Specifically, for example, in a case where the position based on the set of the two types of data is a position Pn, the detection unit 54 determines that one or two messages including the two types of data are authorized messages because the position Pn is inside a boundary B2 of the normal model M2.

Meanwhile, for example, in a case where the position based on the set of the two types of data received from the data acquisition unit 53 is a position Pa, the detection unit 54 determines that one or two messages including the two types of data are unauthorized messages because the position Pa is outside the boundary B2 of the normal model M2.

Here, the normal model M2 is created on the basis of a plurality of sets of two types of data having the same creation times, whereas the positions Pn, Pa are based on sets of two types of data having the same reception times.

In the on-vehicle network 12, transmission of a message is performed at a high speed, and thus, the creation time of data and the reception time of the data can be considered to be substantially the same with each other. Therefore, it is possible to perform detection of an unauthorized message on the basis of a normal model M2 and the position based on a set of two types of data. The transmission time of data is also considered to be substantially the same as the creation time of the data and the reception time of the data.

When having confirmed an unauthorized message, the detection unit 54 performs the following process, for example. That is, the detection unit 54 stores, into the storage unit 52, the ID of one or two messages determined as being unauthorized, the combination of the corresponding types, and the like.

In addition, the detection unit 54 notifies, via the communication processing unit 51, a higher-order device inside or outside the target vehicle 1 that an unauthorized message is being transmitted in a bus 13.

[Effects]

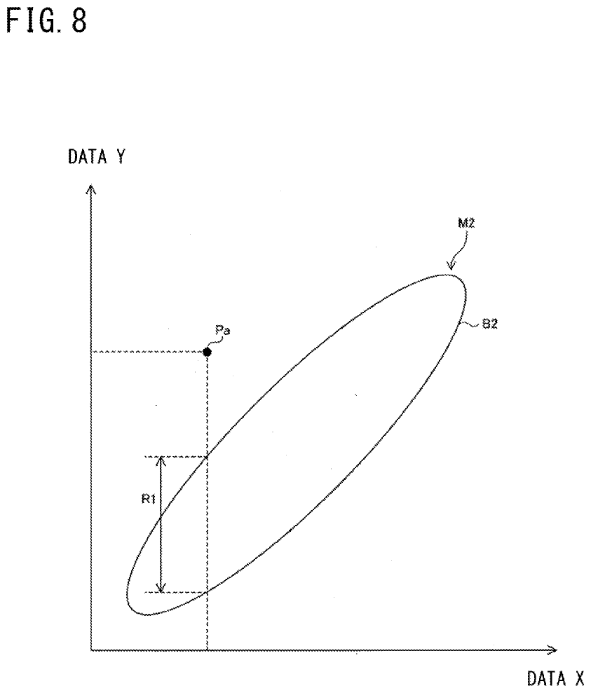

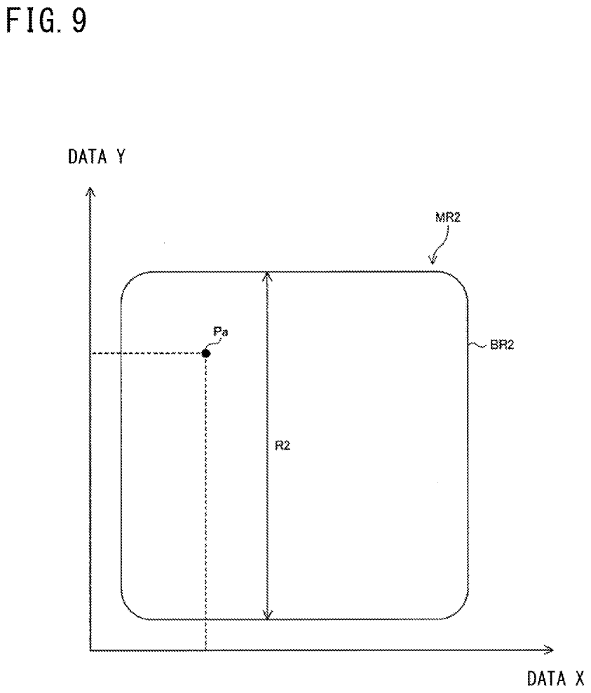

FIG. 8 and FIG. 9 are each a diagram for describing effects of the on-vehicle communication system according to the first embodiment of the present disclosure. The way to interpret FIG. 8 and FIG. 9 is the same as FIG. 4.

The normal model M2 shown in FIG. 8 is the same as the normal model M2 shown in FIG. 7. A normal model MR2 shown in FIG. 9 is a model created in accordance with the same creation procedure as that for the normal model M2, by use of data X and data Y that do not have a correlation therebetween, for example.

The position Pa is determined as abnormal when the normal model M2 is used, whereas the position Pa is determined as normal when the normal model MR2 is used because the position Pa is inside a boundary BR2 of the normal model MR2.

The reason is as follows. As to an allowable range for data Y with respect to the component of data X of the position Pa, an allowable range R2 in FIG. 9 is greater than an allowable range R1 in FIG. 8.

Therefore, in a case where a data field is monitored by use of the normal model M2, even if an attacker has inserted data Y for illegally controlling the target vehicle 1 into a message, the allowable range for data Y is more reduced due to the correlation with data X. Thus, the attack can be properly detected.

In addition, also when an attacker has inserted data X for illegally controlling the target vehicle 1 into a message, the allowable range for data X is more reduced due to the correlation with data Y. Thus, the attack can be properly detected in the same manner.

[Modification 1 of Normal Model]

With reference to FIG. 3 again, the normal model is created on the basis of sets of two types of data that have a predetermined correlation. However, the present disclosure is not limited thereto. The normal model may be created on the basis of sets of three types of data that have a predetermined correlation, for example.

Specifically, a normal model M3 is created on the basis of sets of three types of data that have a predetermined correlation, for example.

More specifically, for example, when there are two types of correlation data that are data having a correlation with a certain type of data, a single normal model M3 is created on the basis of the certain type of data and the two types of correlation data.

More specifically, for example, when the server has determined that, among data 1 to data N at a plurality of common creation times, there is a correlation between data S and data T or there is a strong correlation between data S and data T, and has determined that there is a correlation between data S and data U or there is a strong correlation between data S and data U, the server performs the following process.

That is, irrespective of the magnitude of the correlation coefficient between data T and data U, the server creates a normal model M3 on the basis of data S, T, U. Here, S, T, U are different from one another and are each an integer among 1 to N.

For example, the server creates a plurality of normal models M3, and creates model information for each of the created normal models M3. The model information indicates a normal model M3, and the combination of the types of corresponding data S, data T, and data U.

The combination of the types of data S and data T, and the combination of the types of data S and data U are yaw rate and steer angle, and yaw rate and vehicle height, for example.

The plurality of pieces of model information created by the server are collected to form detection condition information, for example, and the detection condition information is registered into the storage unit 52 during production of the target vehicle 1.

The detection condition information may include only model information based on normal models M3, or may include model information based on normal models M3 and model information based on normal models M2.

The data acquisition unit 53 acquires the detection condition information from the storage unit 52, and acquires a plurality of pieces of model information included in the acquired detection condition information.

When a message that includes data corresponding to the combination indicated by model information has been newly stored into the storage unit 52 by the message acquisition unit 55, the data acquisition unit 53 performs the following process.

That is, on the basis of the model information, the data acquisition unit 53 acquires, from the storage unit 52, a set of three types of data included in the same transmission message, and outputs, to the detection unit 54, the acquired set of the three types of data and the combination of the types indicated by the model information.

Meanwhile, for example, when any one of a plurality of messages respectively including data corresponding to the combination indicated by the model information has been newly stored into the storage unit 52 by the message acquisition unit 55, the data acquisition unit 53 performs the following process.

That is, on the basis of the model information, the data acquisition unit 53 acquires, from the storage unit 52, a set of three types of data respectively included in different transmission messages, and performs a synchronization process on the acquired three types of data.

When the synchronization process is completed, the data acquisition unit 53 acquires the newest set of the three types of data from the synchronized three types of data, and outputs, to the detection unit 54, the acquired set of the three types of data and the combination of the types indicated by the model information.

Upon receiving the set of the three types of data and the combination of the types indicated by the model information from the data acquisition unit 53, the detection unit 54 refers to a plurality of pieces of model information included in the detection condition information in the storage unit 52, and acquires a normal model M3 that corresponds to the received combination, from the corresponding model information in the storage unit 52.

On the basis of the set of the three types of data received from the data acquisition unit 53 and the normal model M3 acquired from the corresponding model information, the detection unit 54 detects an unauthorized message that corresponds to the set.

Specifically, since the normal model M3 is a three-dimensional model, if a position in the three-dimensional space based on the set of the three types of data received from the data acquisition unit 53 exists inside the boundary surface of the normal model M3, the detection unit 54 determines that one, two, or three messages including the three types of data are authorized messages.

Meanwhile, when a position in the three-dimensional space based on the set of the three types of data received from the data acquisition unit 53 exists outside the boundary surface of the normal model M3, the detection unit 54 determines that one, two, or three messages including the three types of data are unauthorized messages.

Due to the configuration using the normal model M3, an unauthorized message can be more accurately detected.

[Modification 2 of Normal Model]

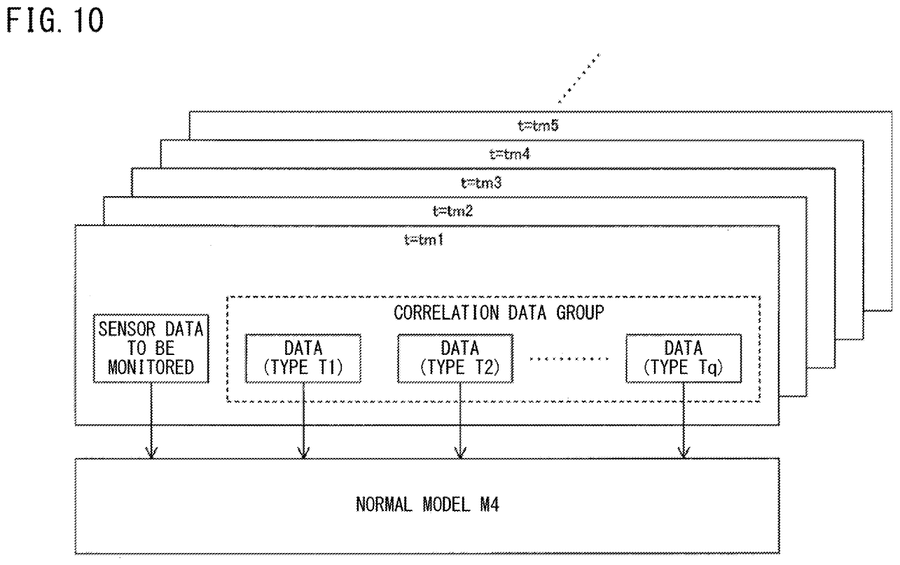

FIG. 10 is a diagram for describing a creation process in a learning phase with respect to a modification of the normal model according to the first embodiment of the present disclosure.

With reference to FIG. 10, with Modification 2 of the normal model, the detection unit 54 detects an unauthorized message in the on-vehicle network 12 by use of an estimated value of sensor data to be monitored.

In this example, a single normal model M4 is created on the basis of sensor data to be monitored and a correlation data group that includes q types of data, for example.

The sensor data to be monitored is data measured by a sensor (hereinafter, also referred to as sensor data), and specifically, is data that continuously varies such as vehicle speed, engine rotation speed, yaw rate, or the like.

The q types of data included in the correlation data group may be sensor data, or status data which is data indicating a state defined in advance. Here, specifically, the status data indicates a state of an operation section such as a gear, a seat belt, or the like in the target vehicle 1, for example.

The sensor data to be monitored and each of the q types of data included in the correlation data group have a correlation with each other. The q types of data included in the correlation data group may or may not have a correlation with one another.

The server causes the normal model M4 to be learned by use of LASSO (Least Absolute Shrinkage and Selection Operator), a regression tree, and the like, on the basis of a learning data set, for example.

Here, the learning data set includes pieces of sensor data to be monitored and correlation data groups that respectively correspond to a plurality of times, specifically, tm1, tm2, tm3, tm4, tm5, and the like.

More specifically, for example, the server creates a normal model M4 such that when a correlation data group corresponding to the same time is inputted into a normal model M4, an estimated value that is close to the value of the corresponding sensor data to be monitored is outputted.

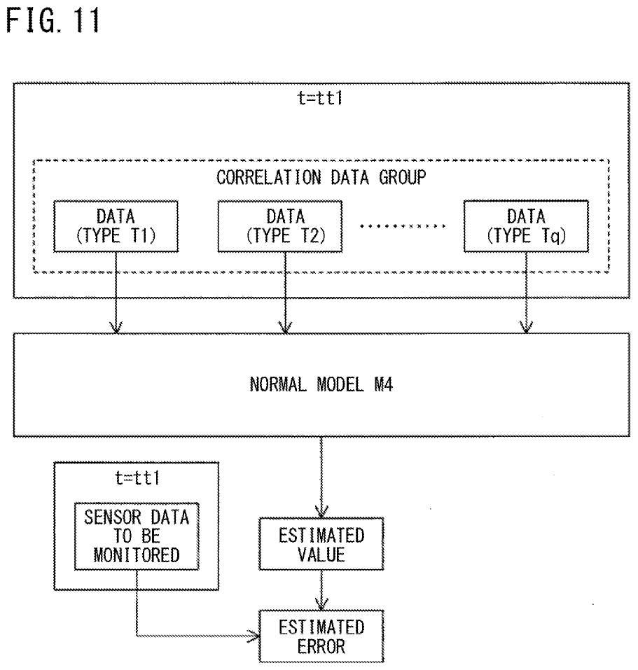

FIG. 11 is a diagram for describing a verification process in a test phase with respect to a modification of the normal model according to the first embodiment of the present disclosure.

With reference to FIG. 11, the normal model M4 is verified by use of a test data set, which is similar to the learning data set.

Specifically, the server creates a distribution of estimated error by use of the normal model M4. More specifically, the server inputs, to the normal model M4, a correlation data group at time tt1 which is a part of the test data set, thereby acquiring an estimated value that is outputted from the normal model M4.

Then, the server calculates an estimated error yerr by use of Formula (1) below, for example.

[Math. 1]

yₑᵣᵣ=y_{obs}−y_{calc} (1)

Here, yobs is a value of corresponding sensor data to be monitored, that is, the value of the sensor data to be monitored at the time tt1. ycalc is an estimated value outputted from the normal model M4.

The server similarly processes sensor data to be monitored and a correlation data group at a time different from the time tt1 in the test data set, thereby creating verification data that includes an estimated error yerr at each of the times.

The server creates a distribution of the estimated error yerr on the basis of the verification data. This distribution represents the frequency of the estimated error yerr. In this example, the distribution is unimodal.

When the created distribution is unimodal, the server calculates a mean value μ and a variance σ\hat{ }2 of the estimated error yerr included in the verification data. Here, “a\hat{ }b” means “a to the power of b.

The server creates model information Md1 that indicates the normal model M4, the mean value μ, and the variance σ\hat{ }2 as well as the combination of the types of the sensor data to be monitored and the q types of data in the correlation data group.

The model information Md1 created by the server is registered into the storage unit 52 as detection condition information during production of the target vehicle 1, for example.

With reference to FIG. 3 again, the data acquisition unit 53 acquires the detection condition information from the storage unit 52, and acquires the model information Md1 included in the acquired detection condition information.

When a message that includes data corresponding to the combination indicated by the model information Md1 has been newly stored into the storage unit 52 by the message acquisition unit 55, the data acquisition unit 53 performs the following process.

That is, on the basis of the model information Md1, the data acquisition unit 53 acquires, from the storage unit 52, a set of the sensor data to be monitored and the correlation data group included in the same transmission message, and outputs, to the detection unit 54, the acquired set and the combination of the types indicated by the model information Md1.

Meanwhile, for example, when any one of a plurality of messages respectively including data corresponding to the combination indicated by the model information Md1 is newly stored into the storage unit 52 by the message acquisition unit 55, the data acquisition unit 53 performs the following process.

That is, on the basis of the model information Md1, the data acquisition unit 53 acquires, from the storage unit 52, a set of the sensor data to be monitored and the correlation data group respectively included in different transmission messages, and performs a synchronization process on the acquired sensor data to be monitored and correlation data group.

When the synchronization process is completed, the data acquisition unit 53 acquires the newest set of the sensor data to be monitored and the correlation data group from the synchronized sensor data to be monitored and correlation data group, and outputs, to the detection unit 54, the acquired set and the combination of the types indicated by the model information Md1.

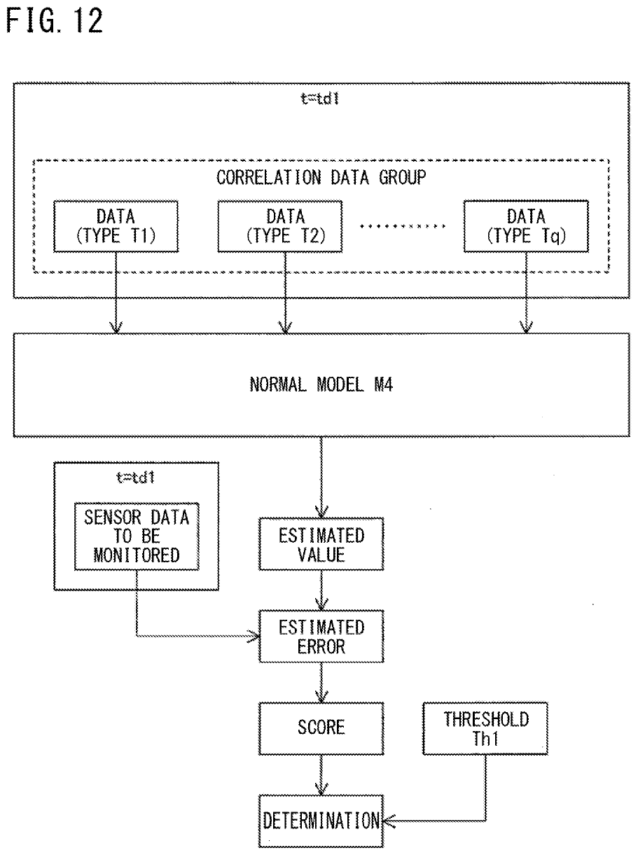

FIG. 12 is a diagram for describing a detection process for an unauthorized message, using a modification of the normal model according to the first embodiment of the present disclosure.

With reference to FIG. 12, for example, when the detection unit 54 has received, from the data acquisition unit 53, a set of sensor data to be monitored and a correlation data group at time td1, and the combination of the types indicated by the model information Md1, the detection unit 54 refers to a plurality of pieces of model information included in the detection condition information in the storage unit 52, and acquires, from the storage unit 52, model information Md1 that corresponds to the received combination.

For example, on the basis of the set of the sensor data to be monitored and the correlation data group acquired by the data acquisition unit 53, and the normal model M4 included in the model information Md1, the detection unit 54 calculates an estimated error of the sensor data to be monitored.

More specifically, the detection unit 54 inputs the correlation data group received from the data acquisition unit 53 into the normal model M4 included in the model information Md1, thereby acquiring an estimated value that is outputted from the normal model M4.

Then, the detection unit 54 substitutes the acquired estimated value and the value of the sensor data to be monitored at time td1 for ycalc and yobs in Formula (1) described above, thereby calculating an estimated error yerr.

For example, on the basis of the calculated estimated error yerr, and the distribution of the estimated error yerr created by use of the normal model M4, the detection unit 54 evaluates the authenticity of the sensor data to be monitored, and on the basis of the evaluation result, determines whether or not the sensor data to be monitored corresponds to an unauthorized message.

More specifically, for example, the detection unit 54 substitutes the calculated estimated error yerr, and the mean value μ and variance σ\hat{ }2 included in the model information Md1 into Formula (2) below, thereby calculating a score S. This score S corresponds to the Mahalanobis distance, and is an evaluation value of the authenticity of the sensor data to be monitored.

$$\begin{matrix}[ Math . 2 ] & \\ S = log \frac{{( {y}_{err} - μ )}^{2}}{{σ}^{2}} & ( 2 )\end{matrix}$$

For example, when the calculated score S is not less than a predetermined threshold Th1, the detection unit 54 determines that the sensor data to be monitored corresponds to an unauthorized message.

Meanwhile, for example, when the calculated score S is smaller than the predetermined threshold Th1, the detection unit 54 determines that the sensor data to be monitored corresponds to an authorized message.

Although the distribution of the estimated error yerr created by the server is assumed to be unimodal, the present disclosure is not limited thereto. The distribution of the estimated error yerr created by the server may be multimodal.

In this case, the server approximates the distribution of the estimated error yerr by a Gaussian mixture distribution composed of K Gaussian distributions, for example, and calculates a mean value μ1 to μK and a variance σ1\hat{ }2 to σK\hat{ }2 of each Gaussian distribution and a mixing proportion C1 to CK of each Gaussian distribution.

For example, the server creates model information Md1 that indicates the normal model M4, the mean value μ1 to μK, the variance σ1\hat{ }2 to σK\hat{ }2, and the mixing proportion C1 to CK, as well as the combination of the types of the sensor data to be monitored and the q types of data in the correlation data group.

In this case, the detection unit 54 substitutes the calculated estimated error yerr, as well as the mean value μ1 to μK, the variance σ1\hat{ }2 to σK\hat{ }2, and the mixing proportion C1 to CK included in the model information Md1, into Formula (3) below, thereby calculating the score S.

$$\begin{matrix}[ Math . 3 ] & \\ S = - log {\sum }_{k = 1}^{K} {C}_{k} \cdot \frac{1}{\sqrt{2 π {σ}_{k}^{2}}} \cdot exp ( B ) & ( 3 )\end{matrix}$$

Here, B in Formula (3) is expressed by Formula (4) below.

$$\begin{matrix}[ Math . 4 ] & \\ B = - \frac{{( {y}_{err} - {μ}_{k} )}^{2}}{2 {σ}_{k}^{2}} & ( 4 )\end{matrix}$$

[Modification 3 of Normal Model]

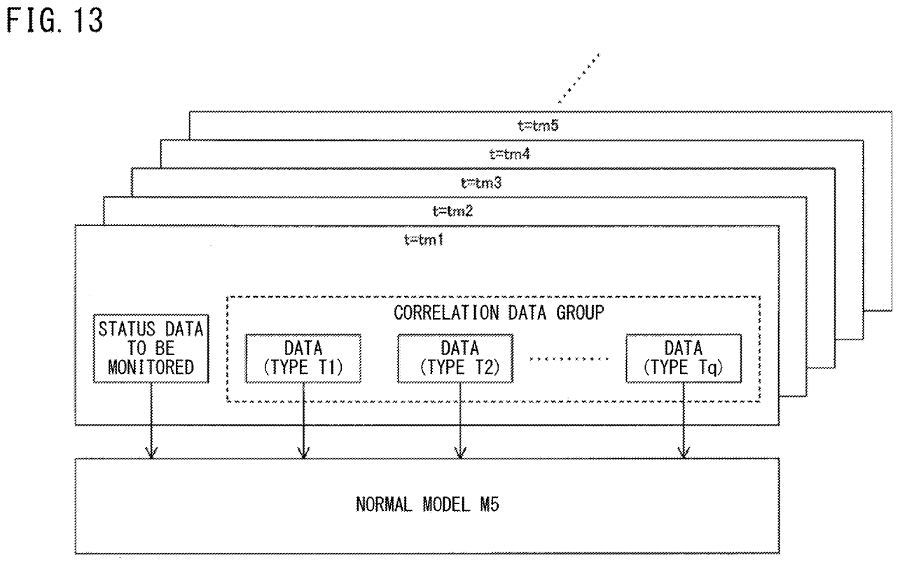

FIG. 13 is a diagram for describing a creation process in a learning phase with respect to a modification of the normal model according to the first embodiment of the present disclosure.

With reference to FIG. 13, with Modification 3 of the normal model, the detection unit 54 detects an unauthorized message in the on-vehicle network 12 by use of an estimated value of status data to be monitored.

In this example, a single normal model M5 is created on the basis of status data to be monitored and a correlation data group that includes q types of data, for example.

The status data to be monitored is status data, and specifically, is data that discontinuously varies in such a case of a gear shift position, a seat belt state, or the like.

The q types of data included in the correlation data group may be sensor data, or may be status data.

The status data to be monitored has a correlation with each of the q types of data included in the correlation data group. The q types of data included in the correlation data group may or may not have a correlation with one another.

The server causes the normal model M5 to be learned by use of a decision tree, Random Forest, and the like, on the basis of a learning data set, for example.

Here, the learning data set includes pieces of status data to be monitored and correlation data groups that respectively correspond to a plurality of times, specifically, tm1, tm2, tm3, tm4, tm5, and the like.

More specifically, for example, the server creates a normal model M5 such that when a correlation data group corresponding to the same time is inputted into a normal model M5, an estimated value that matches the value of the corresponding status data to be monitored is outputted.

The server creates model information Md2 that indicates the normal model M5 as well as the combination of the types of the status data to be monitored and the q types of data in the correlation data group, for example.

The model information Md2 created by the server is registered into the storage unit 52 as detection condition information during production of the target vehicle 1, for example.

With reference to FIG. 3 again, the data acquisition unit 53 acquires the detection condition information from the storage unit 52, and acquires the model information Md2 included in the acquired detection condition information.

When a message that includes data corresponding to the combination indicated by the model information Md2 has been newly stored into the storage unit 52 by the message acquisition unit 55, the data acquisition unit 53 performs the following process.

That is, on the basis of the model information Md2, the data acquisition unit 53 acquires, from the storage unit 52, a set of the status data to be monitored and the correlation data group included in the same transmission message, and outputs, to the detection unit 54, the acquired set and the combination of the types indicated by the model information Md2.

Meanwhile, for example, when any one of a plurality of messages respectively including data corresponding to the combination indicated by the model information Md2 is newly stored into the storage unit 52 by the message acquisition unit 55, the data acquisition unit 53 performs the following process.

That is, on the basis of the model information Md2, the data acquisition unit 53 acquires, from the storage unit 52, a set of the status data to be monitored and the correlation data group respectively included in different transmission messages, and performs a synchronization process on the acquired status data to be monitored and correlation data group.

When the synchronization process is completed, the data acquisition unit 53 acquires the newest set of status data to be monitored and the correlation data group from the synchronized status data to be monitored and correlation data group, and outputs, to the detection unit 54, the acquired set and the combination of the types indicated by the model information Md2.

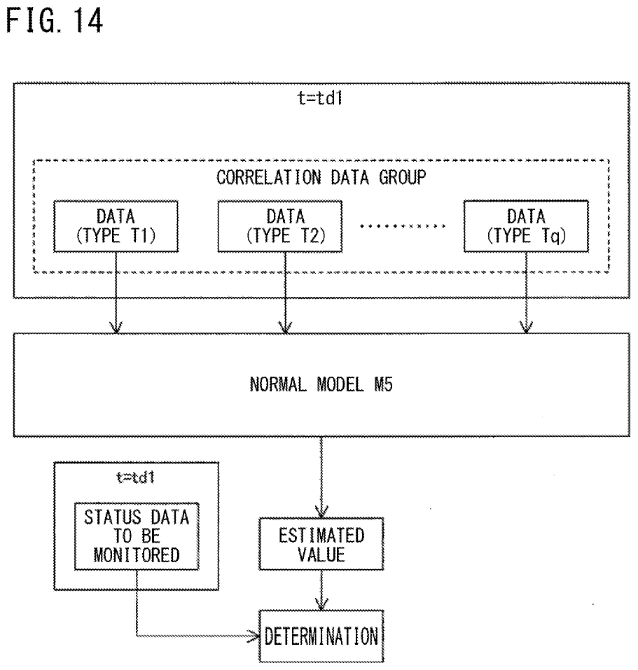

FIG. 14 is a diagram for describing a detection process for an unauthorized message, using a modification of the normal model according to the first embodiment of the present disclosure.

With reference to FIG. 14, for example, when the detection unit 54 has received, from the data acquisition unit 53, a set of status data to be monitored and a correlation data group at time td1, and the combination of the types indicated by the model information Md2, the detection unit 54 refers to a plurality of pieces of model information included in the detection condition information in the storage unit 52, and acquires, from the storage unit 52, model information Md2 that corresponds to the received combination.

For example, on the basis of the correlation data group acquired by the data acquisition unit 53 and the normal model M5 included in the model information Md2, the detection unit 54 estimates a value of the status data to be monitored.

More specifically, the detection unit 54 inputs the correlation data group received from the data acquisition unit 53 into the normal model M5 included in the model information Md2, thereby acquiring an estimated value, of the status data to be monitored, that is outputted from the normal model M5.

Then, on the basis of a result of comparison between the acquired estimated value and the status data to be monitored, the detection unit 54 determines whether or not the status data to be monitored corresponds to an unauthorized message.

More specifically, for example, the detection unit 54 compares the acquired estimated value with the value of the status data to be monitored at time td1, and when these values do not match each other, the detection unit 54 determines that the status data to be monitored corresponds to an unauthorized message.

Meanwhile, for example, when the acquired estimated value and the value of the status data to be monitored at time td1 match each other, the detection unit 54 determines that the status data to be monitored corresponds to an authorized message.

[Modification 4 of Normal Model]

The gateway device 101 is configured to use the normal model M3 based on data S, T, U, but the present disclosure is not limited thereto.

For example, when there are two types of correlation data that are data having a correlation with a certain type of data, two detection conditions are respectively created on the basis of the certain type of data and the two types of correlation data.

Specifically, when the server has determined that, among data 1 to data N at a plurality of common creation times, there is a correlation between data S and data T or there is a strong correlation between data S and data T, and has determined that there is a correlation between data S and data U or there is a strong correlation between data S and data U, the server performs the following process.

That is, irrespective of the magnitude of the correlation coefficient between data T and data U, the server creates a normal model M2 on the basis of data S, T, and creates a normal model M2 on the basis of data S, U.

Due to this configuration, compared with a configuration in which a normal model M3 is created on the basis of data S, T, U, the calculation load in creation of a normal model can be reduced.

[Modification 5 of Normal Model]

The gateway device 101 is configured to use one normal model M3 or two normal models M2 based on data S, T, U, but the present disclosure is not limited thereto.

More specifically, for example, a set of multidimensional data can be converted into a set of lower-dimensional data, by use of the main component analysis described in PATENT LITERATURE 2 (Japanese Laid-Open Patent Publication No. 2016-57438).

Specifically, the server converts a set of three types of data into a set of two types of data by use of the main component analysis, and creates a normal model M2 on the basis of the converted set, for example.

Model information that indicates an eigenvector for converting a set of three types of data into a set of two types of data, a normal model M2 created by the server, and the combination of the types of corresponding data S, data T, and data U, is registered in the storage unit 52 in the gateway device 101.

When the detection unit 54 has received, from the data acquisition unit 53, a set of three types of data and the combination of the types indicated by the model information, the detection unit 54 refers to model information in the storage unit 52, and acquires an eigenvector and a normal model M2 that corresponds to the received combination, from the corresponding model information in the storage unit 52.

Using the acquired eigenvector, the detection unit 54 converts the set of the three types of data received from the data acquisition unit 53 into a set of two types of data, and on the basis of the converted set and the normal model M2, determines whether or not one, two, or three messages including the three types of data are unauthorized messages.

[Operation Flow]

Each device in the on-vehicle communication system 301 includes a computer. An arithmetic processing unit such as a CPU in the computer reads out, from a memory (not shown), a program including a part or all of steps in the sequence diagram or flow chart below, and executes the program. Programs of the plurality of devices can each be installed from outside. The programs of the plurality of devices are each distributed in a state of being stored in a storage medium.

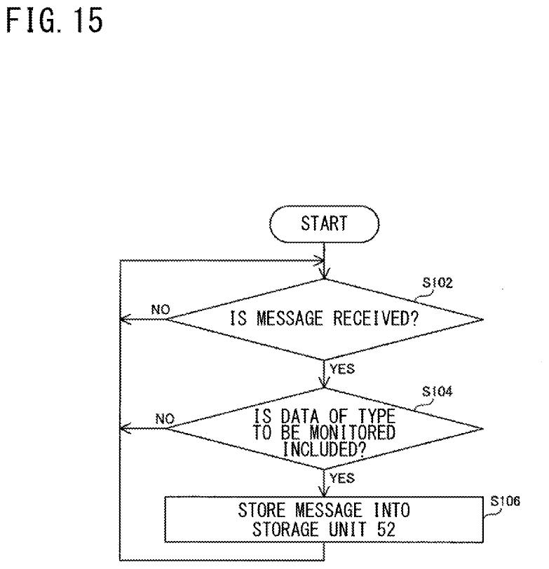

FIG. 15 is a flow chart of a procedure of operation performed when the gateway device according to the first embodiment of the present disclosure receives a message.

With reference to FIG. 15, a situation is assumed in which model information indicates a normal model M2 and the combination of the types of corresponding data X and data Y.

First, the gateway device 101 waits until receiving a message from a control device 122, for example (NO in step S102).

Upon receiving a message from a control device 122 (YES in step S102), the gateway device 101 confirms whether or not data of a type to be monitored is included in the received message (step S104).

Next, when the data of the type to be monitored is included in the received message (YES in step S104), the gateway device 101 stores the received message into the storage unit 52 (step S106). At this time, the gateway device 101 attaches a time stamp to the message.

Next, when the gateway device 101 stores the received message into the storage unit 52 (step S106), or when the data of the type to be monitored is not included in the received message (NO in step S104), the gateway device 101 performs a relay process of the received message, and then waits until receiving a new message from a control device 122 (NO in step S102).

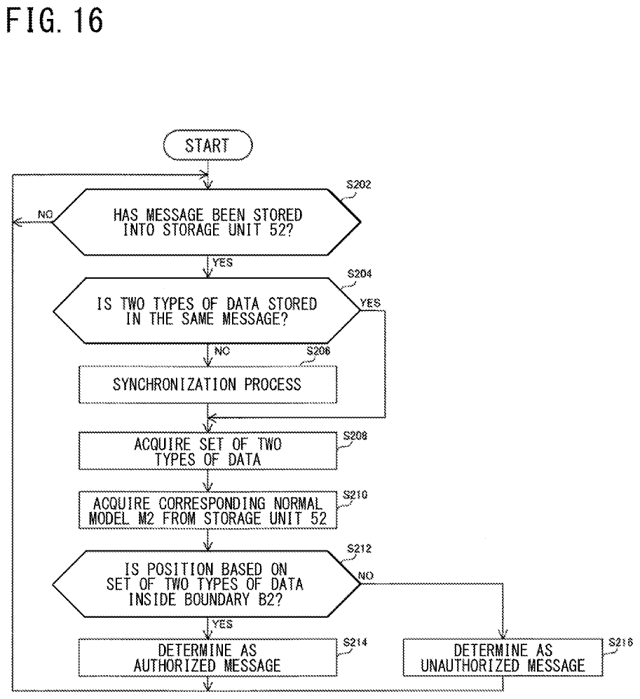

FIG. 16 is a flow chart of a procedure of operation performed when the gateway device according to the first embodiment of the present disclosure has stored a received message into the storage unit.

With reference to FIG. 16, a situation is assumed in which model information indicates a normal model M2 and the combination of the types of corresponding data X and data Y.

First, the gateway device 101 waits until a message is stored into the storage unit 52 (NO in step S202).

Then, when the message has been stored into the storage unit 52 (YES in step S202), the gateway device 101 confirms whether or not data corresponding to the combination of the two types indicated by the model information is stored in the message, i.e., in the same message (step S204).

Next, when data corresponding to the combination of the two types indicated by the model information is not included in the same message, i.e., included in separate messages (NO in step S204), the gateway device 101 performs a synchronization process on the data of the two types indicated by the model information (step S206).

Next, the gateway device 101 acquires, from the message, a set of the data of the two types indicated by the model information, or acquires, from the two types of data having been subjected to the synchronization process, the newest set of data of the two types indicted by the model information (step S208).

Next, the gateway device 101 acquires, from the storage unit 52, a normal model M2 that corresponds to the acquired set of the two types of data (step S210).

Next, the gateway device 101 confirms whether or not the position based on the acquired set of the two types of data is inside the boundary B2 of the normal model M2 (step S212).

When the position based on the acquired set of the two types of data is inside the boundary B2 (YES in step S212), the gateway device 101 determines that one or two messages including the two types of data are authorized messages (step S214).

Meanwhile, when the position based on the acquired set of the two types of data is outside the boundary B2 (NO in step S212), the gateway device 101 determines that one or two messages including the two types of data are unauthorized messages (step S216).

Next, the gateway device 101 waits until a new message is stored into the storage unit 52 (NO in step S202).

In the operation flow above, a situation is assumed in which the model information indicates a normal model M2 and the combination of the types of corresponding data X and data Y. However, the present disclosure is not limited thereto. The model information may indicate a normal model M3, and the combination of the types of corresponding data S, data T, and data U, for example. In this case, in step S208 above, the gateway device 101 acquires a set of the three types of data, and acquires a corresponding normal model M3 from the storage unit 52 in step S210 above.

In the gateway device according to the first embodiment of the present disclosure, the message acquisition unit 55 is configured to acquire a plurality of transmission messages in the on-vehicle network 12. However, the present disclosure is not limited thereto. The message acquisition unit 55 may be configured to acquire one transmission message in the on-vehicle network 12. For example, in a case where data corresponding to the combination of two types indicated by model information is included in the one transmission message, it is possible to determine whether or not the transmission message is an unauthorized message.

In the on-vehicle communication system according to the first embodiment of the present disclosure, the gateway device 101 is configured to detect an unauthorized message in the on-vehicle network 12. However, the present disclosure is not limited thereto. In the on-vehicle communication system 301, a detection device different from the gateway device 101 may detect an unauthorized message in the on-vehicle network 12.

In the gateway device according to the first embodiment of the present disclosure, the data acquisition unit 53 is configured to acquire a set of two types of data and a set of three types of data corresponding to the same reception time. However, the present disclosure is not limited thereto. The data acquisition unit 53 may acquire a set of M types of data corresponding to the same reception time. Here, M is an integer of 4 or greater. In this case, the normal model is created on the basis of the M types of data.

In the gateway device according to the first embodiment of the present disclosure, the data acquisition unit 53 is configured to acquire a set of a plurality of types of data corresponding to the same reception time. However, the present disclosure is not limited thereto. The data acquisition unit 53 may acquire a set of a plurality of types of data corresponding to the same transmission time, the same creation time, or the like, without being limited to the reception time. Specifically, for example, in a case where a control device 122 stores, into a message, the creation time of data or the transmission time of the message, and transmits the message, the data acquisition unit 53 can acquire a set of a plurality of types of data corresponding to the same transmission time or the same creation time.

In the gateway device according to the first embodiment of the present disclosure, the detection unit 54 is configured to use a message transmitted/received between control devices 122 as a detection target for an unauthorized message. However, the present disclosure is not limited thereto. The detection unit 54 may use a message transmitted/received between a control device 122 and an on-vehicle communication device 111, and a message transmitted/received between on-vehicle communication devices 111 as detection targets for an unauthorized message.

In the gateway device according to the first embodiment of the present disclosure, the normal model is created on the basis of sets of a plurality of types of data that have a predetermined correlation. However, the present disclosure is not limited thereto. The normal model may be created on the basis of sets of a plurality of types of data that do not have a predetermined correlation.

In the gateway device according to the first embodiment of the present disclosure, the data acquisition unit 53 is configured to acquire a plurality of types of data from transmission messages stored in the storage unit 52 by the message acquisition unit 55, and resample the acquired data. However, the present disclosure is not limited thereto. For example, in a case where the reception times of the transmission messages are close to each other, the data acquisition unit 53 may directly receive the transmission messages from the message acquisition unit 55, acquire a plurality of types of data from the received transmission messages, and use the acquired data in the detection without resampling the acquired data.

Meanwhile, PATENT LITERATURE 1 discloses a configuration in which a first encryption key to be used in message authentication by a first ECU and a second ECU which are connected only to an on-vehicle network is different from a second encryption key to be used by a third ECU connected to both the on-vehicle network and an external network, thereby preventing cyberattack from the external network on the first ECU and the second ECU which are not connected to the external network.

However, in a case of a security measure that uses message authentication, the security measure could be invalidated by an attack on vulnerability of a protocol, an attack using the first encryption key illegally obtained, an attack on an obsolete encryption algorithm, or the like.

In a case where such an attack has been made, a technology for properly detecting intrusion of an attacker into the on-vehicle network is required.

In contrast, the gateway device according to the first embodiment of the present disclosure detects an unauthorized message in the on-vehicle network 12 mounted in the target vehicle 1. The message acquisition unit 55 acquires one or a plurality of transmission messages in the on-vehicle network 12. The data acquisition unit 53 acquires a set of a plurality of types of data that are included in the transmission messages acquired by the message acquisition unit 55 and that correspond to the same time. The storage unit 52 stores a detection condition created in advance and based on a plurality of sets that respectively correspond to a plurality of times. The detection unit 54 detects an unauthorized message on the basis of the set acquired by the data acquisition unit 53 and the detection condition.

For example, in a case where there is a certain relationship between a plurality of types of data, if the relationship is used, it is possible to calculate, from certain data, a range of the values that another data can take. Due to the above configuration, for example, from the certain data in the above set, a range of the values that the other data in the set can take can be calculated on the basis of the detection condition. Thus, the authenticity of the other data can be properly determined. Accordingly, a message that includes data determined as unauthorized can be detected as an unauthorized message. Therefore, an unauthorized message in the on-vehicle network can be properly detected.

In the gateway device according to the first embodiment of the present disclosure, the detection condition is created on the basis of sets of a plurality of types of data that have a predetermined correlation.

Due to the configuration in which a detection condition is created on the basis of sets of a plurality of types of data between which some relationship exists, it is possible to create a detection condition that allows, on the basis of certain data in a set, reduction of the range of the values that another data in the set can take. Accordingly, the authenticity of the other data can be more properly determined. That is, an appropriate detection condition can be created.

In the gateway device according to the first embodiment of the present disclosure, when there are a plurality of types of correlation data that are data having a correlation with a certain type of data, a single detection condition is created on the basis of the certain type of data and the plurality of types of correlation data.

Due to this configuration, for example, even when an attacker has modified part of data in the certain type of data and the plurality of types of correlation data, it is possible to determine an abnormality of data in the above set, on the basis of the relationship between the modified data and the residual data. That is, in order to make illegal intrusion, the attacker has to modify all of the certain type of data and the plurality of types of correlation data. Thus, illegal intrusion into the on-vehicle network 12 can be made difficult. Accordingly, security in the on-vehicle network 12 can be improved.

In the gateway device according to the first embodiment of the present disclosure, the detection unit 54 calculates an estimated error of a certain type of data on the basis of the certain type of data and the plurality of types of correlation data acquired by the data acquisition unit 53 and the detection condition. Then, the detection unit 54 evaluates the authenticity of the certain type of data on the basis of the calculated estimated error and the distribution of the estimated error created by use of the detection condition, and determines whether or not the certain type of data is an unauthorized message, on the basis of the result of the evaluation.

Due to this configuration, for example, in a case where a certain type of data is composed of a value that continuously varies such as a value measured by a sensor, the possibility that the certain type of data has a proper value can be more accurately evaluated. Therefore, the authenticity of the certain type of data can be more properly determined.

In the gateway device according to the first embodiment of the present disclosure, a certain type of data is data that indicates a state. The detection unit 54 estimates a value of the certain type of data on the basis of the plurality of types of correlation data acquired by the data acquisition unit 53 and the detection condition, and determines whether or not the certain type of data corresponds to an unauthorized message, on the basis of the result of comparison between the estimated value and the certain type of data.

Due to this configuration, for example, in case where a certain type of data is composed of a value that discontinuously varies in such a case of a gear shift position or a seat belt state, a value that the certain type of data should indicate can be more properly estimated. Thus, the authenticity of the certain type of data can be more properly determined.

In the gateway device according to the first embodiment of the present disclosure, when there are a plurality of types of correlation data that are data having a correlation with a certain type of data, a plurality of detection conditions are created on the basis of the certain type of data and the plurality of types of correlation data, respectively.

Due to this configuration, illegal intrusion into the on-vehicle network 12 can be made difficult, and the calculation load in calculation of the detection condition can be reduced.

In the gateway device according to the first embodiment of the present disclosure, the data acquisition unit 53 acquires a set of a plurality of types of data respectively included in different transmission messages.

A plurality of types of data whose reception times, transmission times, creation times, or the like are different from each other are respectively included in different transmission messages in many cases. Due to the above configuration, the types of data to be detected can be prevented from being restricted because of time.

In the gateway device according to the first embodiment of the present disclosure, the message acquisition unit 55 stores, into the storage unit 52, a plurality of transmission messages having been acquired. Then, the data acquisition unit 53 acquires the above-described set from the transmission messages stored in the storage unit 52.

Due to this configuration, for example, data in the plurality of transmission messages stored in the storage unit 52 can be resampled, and thus, the times of a plurality of types of data can be adjusted to the same time. Accordingly, a set of a plurality of types of data corresponding to the same time can be easily acquired.

Next, another embodiment of the present disclosure is described with reference to the drawings. In the drawings, the same or corresponding parts are denoted by the same reference signs, and descriptions thereof are not repeated.

### Second Embodiment

The present embodiment relates to a gateway device that updates a normal model, when compared with the gateway device according to the first embodiment. The gateway device according to the present embodiment is the same as the gateway device according to the first embodiment, except for the contents described below.

[Problem]

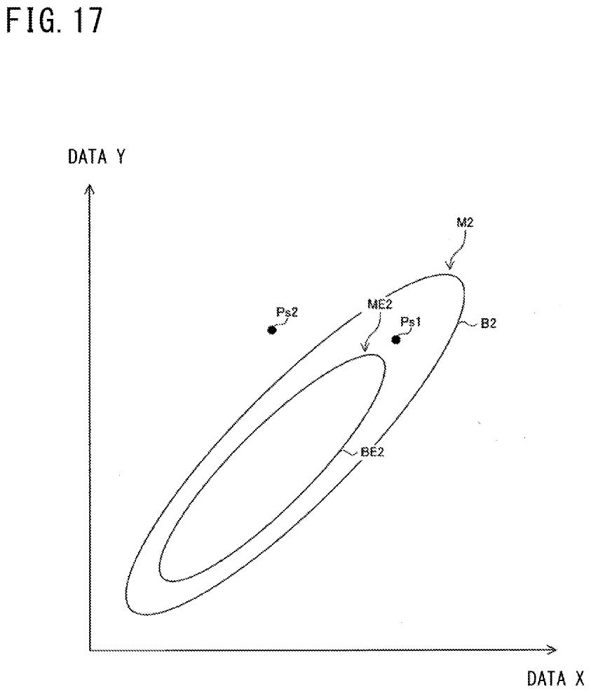

FIG. 17 is a diagram for describing one example of erroneous detection in a gateway device according to the second embodiment of the present disclosure. The way to interpret FIG. 17 is the same as FIG. 4.

With reference to FIG. 17, a normal model M2 is a model based on sets (hereinafter, also referred to as population) of data X and data Y at a plurality of common creation times shown in FIG. 4. This population is data acquired so as to have a reduced bias, during development of the target vehicle 1. Therefore, this population is close to a true population.

For example, when the data acquired during development of the target vehicle 1 is biased, a normal model ME2 based on a biased population is created.

In a case where unauthorized message detection is performed by use of the normal model ME2, since positions Ps1, Ps2 are outside a boundary BE2 of the normal model ME2, a message that includes data X or data Y of the position Ps1 and a message that includes data X or data Y of the position Ps2 are determined as unauthorized messages.

However, the position Ps1 is inside the boundary B2 of the normal model M2, which is more accurate. Therefore, when the normal model ME2 is used, determining that the message that includes data X or data Y of the position Ps1 is an unauthorized message corresponds to erroneous detection.

Also when the population of the normal model ME2 created in advance is biased, a technology that enables use of a more accurate normal model is required.

[Configuration and Basic Operation]

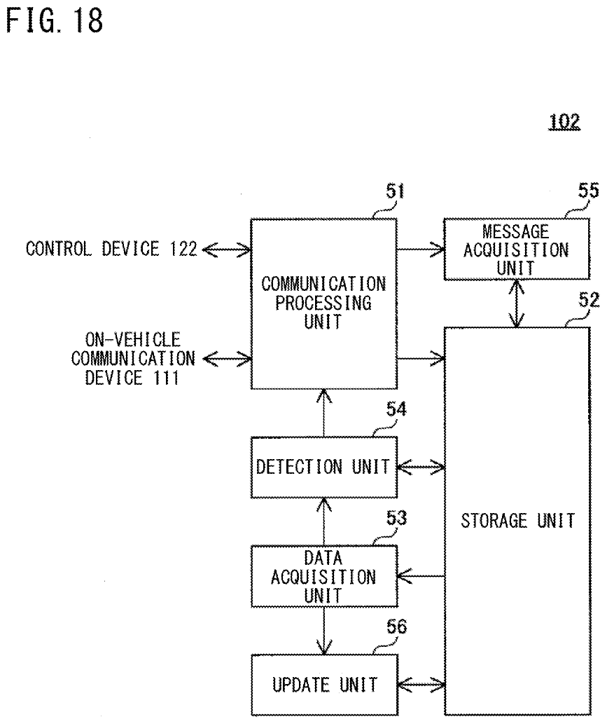

FIG. 18 shows a configuration of a gateway device in the on-vehicle communication system according to the second embodiment of the present disclosure.

With reference to FIG. 18, a gateway device (detection device) 102 includes a communication processing unit 51, a storage unit 52, a data acquisition unit 53, a detection unit 54, a message acquisition unit 55, and an update unit 56.

Operations of the communication processing unit 51, the storage unit 52, the data acquisition unit 53, the detection unit 54, and the message acquisition unit 55 in the gateway device 102 are the same as those of the communication processing unit 51, the storage unit 52, the data acquisition unit 53, the detection unit 54, and the message acquisition unit 55 in the gateway device 101 shown in FIG. 3, respectively.

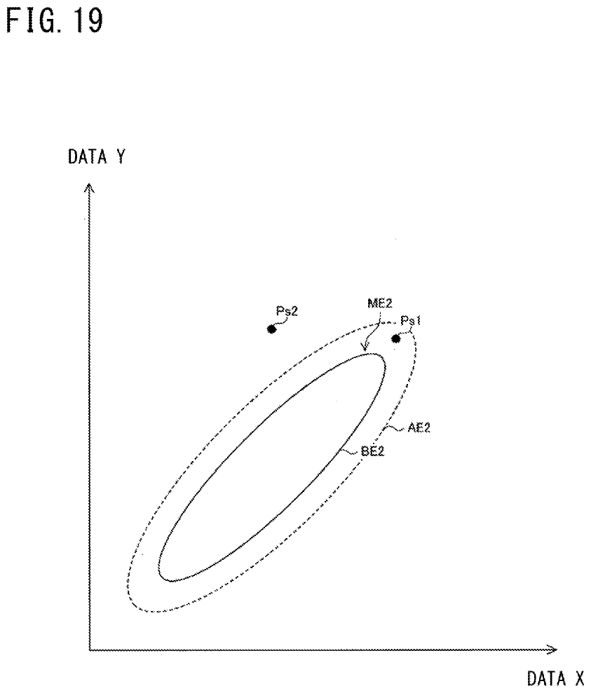

FIG. 19 is a diagram for describing update of a normal model performed by the update unit in the gateway device according to the second embodiment of the present disclosure. The way to interpret FIG. 19 is the same as FIG. 4.

With reference to FIG. 18 and FIG. 19, a situation is assumed in which detection condition information that includes model information indicating the normal model ME2 and the combination of the types of corresponding data X and data Y is registered in the storage unit 52.

The data acquisition unit 53 acquires the detection condition information from the storage unit 52 and acquires a plurality of pieces of model information included in the acquired detection condition information.

For example, the data acquisition unit 53 acquires, from the storage unit 52, a set of two types of data on the basis of the acquired model information.

Here, a situation is assumed in which a set of data X and data Y is included in the same transmission message. For example, when the transmission message is newly stored into the storage unit 52 by the message acquisition unit 55, the data acquisition unit 53 acquires, from the transmission message, a set of data X and data Y on the basis of the combination indicated by the model information.

The data acquisition unit 53 outputs the acquired set of data X and data Y and the combination of the types indicated by the model information, to the detection unit 54 and the update unit 56.

For example, the update unit 56 updates the detection condition on the basis of the set acquired by the data acquisition unit 53.

More specifically, for example, in the gateway device 102, an update period in which the normal model should be updated is preset by a user, and the update unit 56 updates the normal model in the update period.

Specifically, upon receiving, from the data acquisition unit 53, the set of data X and data Y and the combination of the types indicated by the model information, the update unit 56 refers to a plurality of pieces of model information included in the detection condition information in the storage unit 52, and acquires a normal model ME2 that corresponds to the received combination, from the corresponding model information in the storage unit 52.

Then, when the time is in the update period, the update unit 56 sets a boundary AE2 indicating an allowable range, on the basis of the acquired normal model ME2, in accordance with a predetermined algorithm. The boundary AE2 is positioned outside the boundary BE2 of the normal model ME2.

When the position based on the set of data X and data Y is outside the boundary AE2 as in the case of the position Ps2, the update unit 56 does not update the normal model ME2.

Meanwhile, when the position based on the set of data X and data Y is inside the boundary AE2 as in the case of the position Ps1, the update unit 56 updates the normal model ME2.

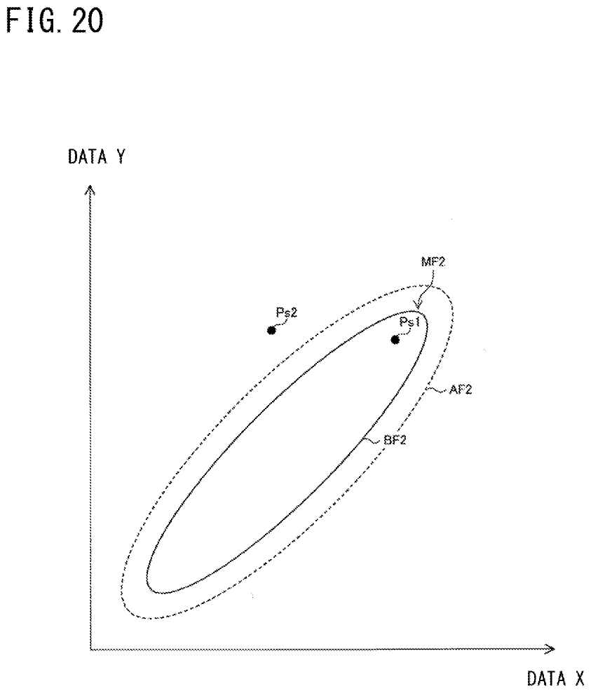

FIG. 20 is a diagram for describing a normal model updated by the update unit in the gateway device according to the second embodiment of the present disclosure. The way to interpret FIG. 20 is the same as FIG. 4.

With reference to FIG. 18 and FIG. 20, for example, the update unit 56 creates a normal model MF2 by updating the normal model ME2 on the basis of the set of data X and data Y of the position Ps1. A boundary AF2 is a boundary that corresponds to the normal model MF2, and is positioned outside a boundary BF2 of the normal model MF2.

The data acquisition unit 53 updates the model information that is stored in the storage unit 52 and that indicates the normal model ME2 and the combination of the types of corresponding data X and data Y, into model information that indicates the normal model MF2 and the combination of the type of corresponding data X and data Y.

Since the position Ps1 is inside the boundary BF2 of the updated normal model MF2, if the updated normal model MF2 is used, it is possible to properly determine that the message including data X or data Y of the position Ps1 is an authorized message.

In addition, if the update unit 56 further updates the normal model MF2 in the update period, the normal model MF2 can be made closer to a normal model that is based on a true population.

In the gateway device according to the second embodiment of the present disclosure, the update unit 56 updates the detection condition on the basis of a set of two types of data. However, the present disclosure is not limited thereto. The update unit 56 may update the detection condition on the basis of a set of three or more types of data.

The other configurations and operations are the same as those of the gateway device according to the first embodiment. Thus, detailed description thereof is not repeated here.

As described above, in the gateway device according to the second embodiment of the present disclosure, the update unit 56 updates the detection condition on the basis of a set acquired by the data acquisition unit 53.

Due to this configuration, for example, even if the sets used in calculation of the detection condition are not perfect as a population, a newly acquired set can be included in the population. Thus, the degree of perfection of the population can be more enhanced. Accordingly, the detection condition can be updated to a more appropriate detection condition.

Next, another embodiment of the present disclosure is described with reference to the drawings. In the drawings, the same or corresponding parts are denoted by the same reference signs, and descriptions thereof are not repeated.

### Third Embodiment

The present embodiment relates to a gateway device in which unauthorized message detection based on a message transmission interval is incorporated, when compared with the gateway device according to the first embodiment. The gateway device according to the present embodiment is the same as the gateway device according to the first embodiment, except for the contents described below.

[Configuration and Basic Operation]

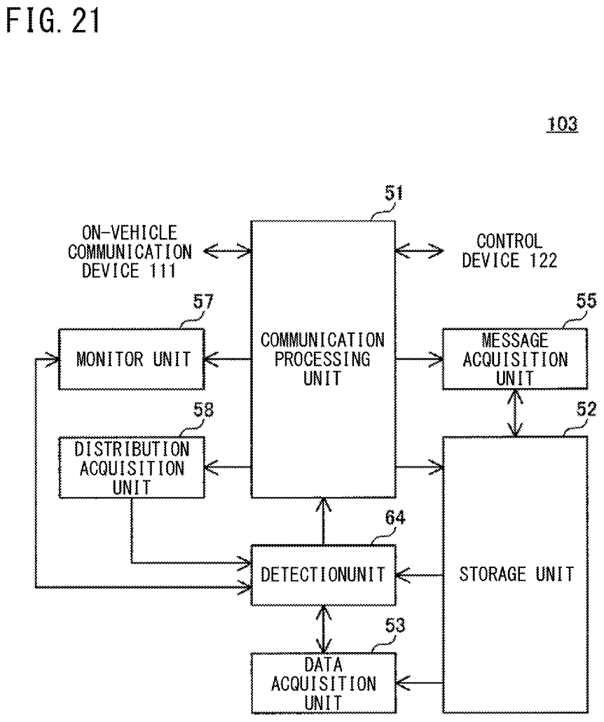

FIG. 21 shows a configuration of a gateway device in the on-vehicle communication system according to the third embodiment of the present disclosure.

With reference to FIG. 21, a gateway device (detection device) 103 includes a communication processing unit 51, a storage unit 52, a data acquisition unit 53, a message acquisition unit 55, a monitor unit 57, a distribution acquisition unit 58, and a detection unit 64.

Operations of the communication processing unit 51, the storage unit 52, the data acquisition unit 53, and the message acquisition unit 55 in the gateway device 103 are the same as those of the communication processing unit 51, the storage unit 52, the data acquisition unit 53, and the message acquisition unit 55 in the gateway device 101 shown in FIG. 3, respectively.

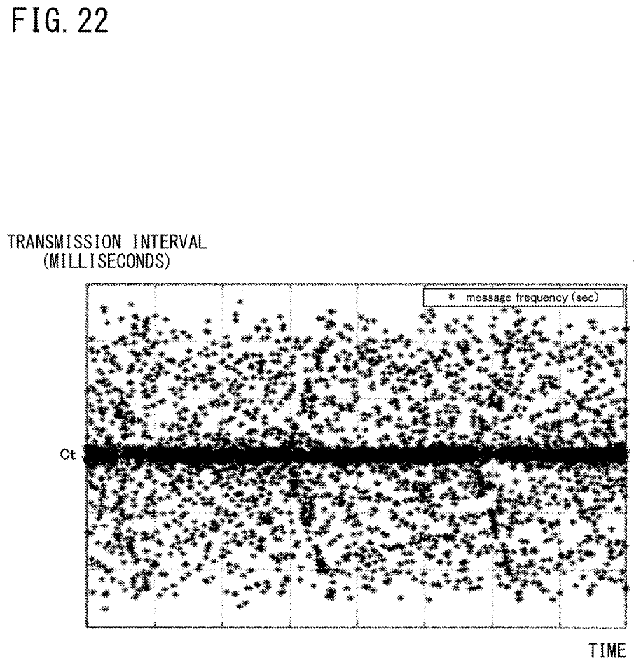

FIG. 22 shows one example of temporal change in a transmission interval of a periodic message to be monitored in the on-vehicle communication system according to the third embodiment of the present disclosure. In FIG. 22, the vertical axis represents transmission interval and the horizontal axis represents time.

With reference to FIG. 22, the transmission interval is an interval of timing at which a certain periodic message to be monitored (hereinafter, also referred to as target message) is transmitted in a bus 13, for example.

As shown in FIG. 22, the transmission interval of the target message is not constant and is varied. This is because arbitration is performed when the target message is transmitted or delay variation occurs in internal processing due to deviation of the clock, for example.

Here, the arbitration is described. Each message is assigned with a priority in accordance with an ID, for example. For example, when transmission timings of a plurality of messages overlap each other, arbitration is performed in the on-vehicle network 12 such that a message having a higher priority is transmitted in a bus 13, in preference to a message having a lower priority. Due to such arbitration, variation in the transmission interval occurs.

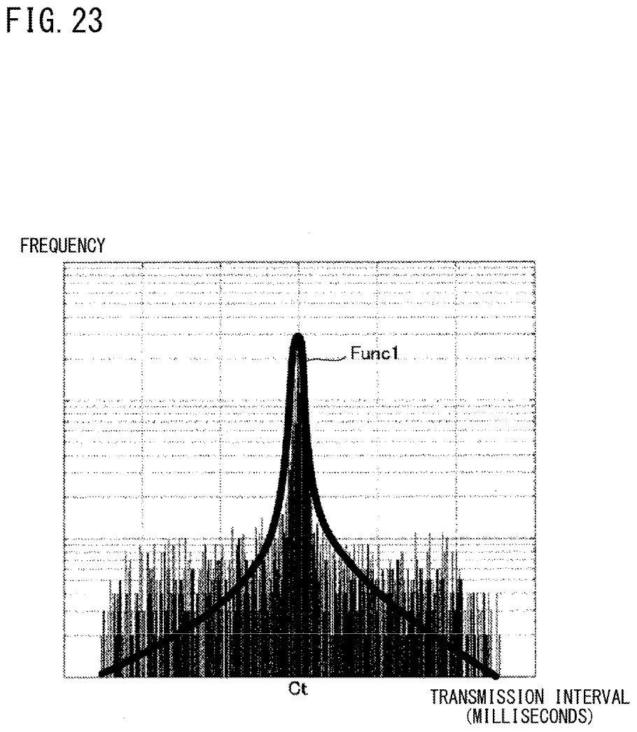

FIG. 23 shows one example of a frequency distribution of target message transmission interval in the on-vehicle communication system according to the third embodiment of the present disclosure. In FIG. 23, the vertical axis represents frequency and the horizontal axis represents transmission interval.

With reference to FIG. 23, the frequency distribution of transmission interval is substantially symmetric with respect to Ct milliseconds. The frequency distribution of transmission interval can be approximated by a predetermined model function Func1, for example.

With reference to FIG. 21 again, the monitor unit 57 monitors transmission messages in the on-vehicle network 12, for example. More specifically, for example, the monitor unit 57 monitors the message relay process in the communication processing unit 51, and measures the transmission interval of the target message on the basis of the monitoring result.

Specifically, for example, one ID that indicates the target message (hereinafter, also referred to as registered ID) is registered in the monitor unit 57. It should be noted that a plurality of registered IDs may be registered in the monitor unit 57.

For example, when the communication processing unit 51 has received a message, the monitor unit 57 confirms an ID included in the message received by the communication processing unit 51. When the confirmed ID matches the registered ID, the monitor unit 57 maintains, as a measurement reference, a reception time t1 of the message, i.e., the target message, received by the communication processing unit 51, for example.

Then, when a new target message including the registered ID has been received in the communication processing unit 51, the monitor unit 57 maintains a reception time t2 of the newly received target message, and performs the following process.

That is, by subtracting the reception time t1 from the reception time t2, the monitor unit 57 calculates a transmission interval of the target message, and outputs the calculated transmission interval and the registered ID, to the detection unit 64.

The distribution acquisition unit 58 acquires a distribution of transmission interval of transmission message, for example. Specifically, the distribution acquisition unit 58 acquires distribution information that indicates a distribution of transmission interval created in advance by another device, specifically, a server, for example.

More specifically, for example, the server acquires a plurality of transmission intervals of the target message. These transmission intervals are measured in a test vehicle of the same type as the target vehicle 1, for example. The server may acquire transmission intervals measured in the target vehicle 1.

For example, as the model function Func1, the server uses a probability density function p of normal distribution (hereinafter, also referred to as normal distribution function) which is shown in Formula (5) below and which has x as a variable.

$$\begin{matrix}[ Math . 5 ] & \\ p ( x \vert \overline{x} , {σ}^{2} ) = \frac{1}{\sqrt{2 {πσ}^{2}}} exp \{ - \frac{{( x - \overline{x} )}^{2}}{2 {σ}^{2}} \} & ( 5 )\end{matrix}$$

Here, x-bar and σ\hat{ }2 are parameters and are respectively a mean value and a variance of a plurality of transmission intervals. The x-bar and σ\hat{ }2 are respectively calculated by Formulas (6) and (7) below.

$$\begin{matrix}[ Math . 6 ] & \\ \overline{x} = \frac{1}{t} {\sum }_{i = 1}^{t} {x}_{i} & ( 6 ) \\ [ Math . 7 ] & \\ {σ}^{2} = \frac{1}{t} {\sum }_{i = 1}^{t} {( {x}_{i} - \overline{x} )}^{2} & ( 7 )\end{matrix}$$

Here, t is the number of samples of transmission intervals. xi denotes the i-th transmission interval. The server transmits, to the target vehicle 1, distribution information that includes x-bar and σ\hat{ }2 at a predetermined distribution timing, for example.

Upon receiving the distribution information from the server via an on-vehicle communication device 111 and the communication processing unit 51, the distribution acquisition unit 58 creates a model function Func1 represented by Formula (5), on the basis of the received distribution information, and outputs the created model function Func1 to the detection unit 64.

In the gateway device 103, the distribution acquisition unit 58 receives the distribution information from the server via an on-vehicle communication device 111 and the communication processing unit 51, and outputs the distribution information to the detection unit 64. However, the present disclosure is not limited thereto. For example, the gateway device 103 may have a nonvolatile memory, and from the nonvolatile memory in which distribution information is written via the port 112 by the maintenance terminal device, the distribution acquisition unit 58 may acquire the distribution information and output the distribution information to the detection unit 64.

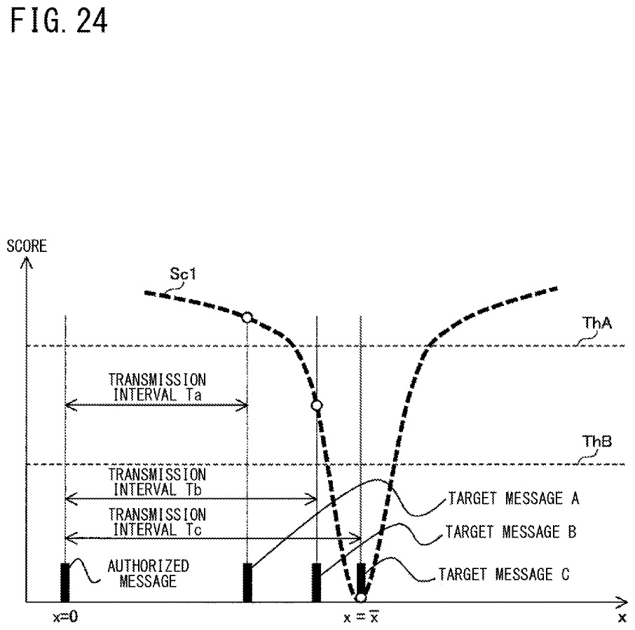

FIG. 24 shows an example of unauthorized message detection performed by the detection unit in the gateway device according to the third embodiment of the present disclosure. In FIG. 24, the vertical axis represents score and the horizontal axis represents variable x.

With reference to FIG. 24, the detection unit 64 detects an unauthorized message on the basis of a monitoring result by the monitor unit 57 and a distribution of transmission interval acquired by the distribution acquisition unit 58, for example.

Specifically, on the basis of transmission intervals measured by the monitor unit 57, distribution information that indicates the distribution of the transmission intervals, and a predetermined threshold, the detection unit 64 determines whether or not the transmission message should be determined as an unauthorized message. Here, a threshold ThB is registered in the detection unit 64.

In other words, the detection unit 64 detects an unauthorized message on the basis of a position, in the distribution, of a transmission interval measured by the monitor unit 57, for example.

Upon receiving the model function Func1 from the distribution acquisition unit 58, the detection unit 64 creates a score function Sc1 by transforming the received model function Func1. More specifically, the detection unit 64 creates, −log(Func1) as the score function Sc1, for example. Here, “log(c)” means a common logarithm of c.

In FIG. 24, the score function Sc1 is expressed such that the measurement reference time corresponds to x=0. Therefore, the horizontal axis shown in FIG. 24 represents transmission interval. The score function Sc1 indicates a minimum value when the variable x is the mean value, i.e., x-bar.

The detection unit 64 calculates a score by substituting the transmission interval received from the monitor unit 57, into the variable x in the score function Sc1.

When the calculated score is not greater than the threshold ThB, the detection unit 64 determines that the target message transmitted this time should not be determined as an unauthorized message, i.e., determines that the target message is an authorized message or a message having a pseudo transmission interval (hereinafter, also referred to as pseudo message). Specifically, when having received a transmission interval Tc shown in FIG. 24 from the monitor unit 57, the detection unit 64 determines that the target message C transmitted this time is an authorized message or a pseudo message.

The reason for this is as follows. That is, when the target message is an authorized message or a pseudo message, for example, even if variation due to arbitration, delay of internal processing, and the like is included, there is a high possibility that the transmission interval is positioned in the vicinity of the center of the frequency distribution shown in FIG. 23.

Meanwhile, when the calculated score is greater than the threshold ThB, the detection unit 64 determines that the target message transmitted this time is an unauthorized message. Specifically, when having received a transmission interval Ta shown in FIG. 24 from the monitor unit 57, the detection unit 64 determines that a target message A transmitted this time is an unauthorized message. Similarly, when having received a transmission interval Tb from the monitor unit 57, the detection unit 64 determines that a target message B transmitted this time is an unauthorized message.

The reason for this is as follows. That is, when the target message is an unauthorized message, for example, there is a high possibility that the target message is not transmitted in accordance with a predetermined rule.

In a case where the level of security is to be decreased, the threshold registered in the detection unit 64 is changed to ThA that is greater than ThB. Accordingly, for example, as in the case of the target message B corresponding to the transmission interval Tb, a message determined as an unauthorized message by the detection unit 64 is determined as an authorized message or a pseudo message after the threshold has been changed.

The detection unit 64 notifies the monitor unit 57 of the determination result based on the transmission interval received from the monitor unit 57.

The monitor unit 57 uses, as a measurement reference for transmission interval, the reception timing of the transmission message determined as an authorized message or a pseudo message, for example.

More specifically, when the determination result notified of from the detection unit 64 indicates that the target message transmitted this time is an authorized message or a pseudo message, the monitor unit 57 uses the reception time t2 as a new measurement reference for transmission interval.

Then, when a new target message including the registered ID has been received in the communication processing unit 51, the monitor unit 57 maintains a reception time t3 of the newly received target message, and performs the following process.

That is, by subtracting the reception time t2 from the reception time t3, the monitor unit 57 calculates a new transmission interval of the target message, and outputs the calculated transmission interval to the detection unit 64.

Meanwhile, when the determination result notified of from the detection unit 64 indicates that the target message transmitted this time is an unauthorized message, the monitor unit 57 maintains the reception time t1 as the measurement reference.

Then, when a new target message including the registered ID has been received in the communication processing unit 51, the monitor unit 57 maintains the reception time t3 of the newly received target message, and performs the following process.

That is, by subtracting the reception time t1 from the reception time t3, the monitor unit 57 calculates a new transmission interval of the target message, and outputs the calculated transmission interval to the detection unit 64.

For example, with respect to a transmission message that has been determined as not to be classified as an unauthorized message, the detection unit 64 determines whether or not the transmission message is an unauthorized message, on the basis of the set acquired by the data acquisition unit 53 and the detection condition.

More specifically, when having determined that the target message C transmitted this time is an authorized message or a pseudo message, the detection unit 64 outputs, to the data acquisition unit 53, the registered ID received from the monitor unit 57.

Upon receiving the registered ID from the detection unit 64, the data acquisition unit 53 acquires the newest message that has the received registered ID, i.e., the newest target message, from among a plurality of messages stored in the storage unit 52.

In this example, one piece of data is included in the target message. The data acquisition unit 53 recognizes the type (hereinafter, also referred to as target type) of the one piece of data included in the acquired newest target message. It should be noted that two or more pieces of data may be included in the target message.

The data acquisition unit 53 refers to a plurality of pieces of model information included in the detection condition information stored in the storage unit 52, and acquires, from the storage unit 52, model information that indicates the recognized target type, from among the plurality of pieces of model information referred to.

The data acquisition unit 53 specifies a type of data (hereinafter, also referred to as counterpart type) to be combined with the target type, on the basis of the acquired model information.

For example, the data acquisition unit 53 acquires, from the storage unit 52, a plurality of target messages that include data of the target type, and a plurality of messages that includes data of the counterpart type, and performs a synchronization process for synchronizing the reception time of the target-type data and the reception time of the counterpart-type data on the basis of the acquired messages.

When the synchronization process is completed, the data acquisition unit 53 acquires a set of the newest two types of data from the synchronized two types of data, and outputs, to the detection unit 64, the acquired set of the two types of data and the combination of the types indicated by the model information.

Upon receiving the set of the two types of data and the combination of the types indicated by the model information from the data acquisition unit 53, the detection unit 64 refers to a plurality of pieces of model information included in the detection condition information in the storage unit 52, and acquires a normal model M2 that corresponds to the received combination, from the corresponding model information in the storage unit 52.

On the basis of the position based on the set of the two types of data received from the data acquisition unit 53, and the acquired normal model M2, the detection unit 64 determines whether or not the target message is an unauthorized message.

Specifically, as shown in FIG. 7, when the position based on the set of the two types of data received from the data acquisition unit 53 is the position Pn, the detection unit 64 determines that the target message is an authorized message because the position Pn is inside the boundary B2 of the normal model M2.

Meanwhile, when the position based on the set of the two types of data received from the data acquisition unit 53 is the position Pa, the detection unit 64 determines that the target message is a pseudo message, i.e., an unauthorized message because the position Pa is outside the boundary B2 of the normal model M2.

When having determined that the target message is an unauthorized message, the detection unit 64 performs the following process, for example. That is, the detection unit 64 stores, into the storage unit 52, the registered ID, the ID of the message that includes the counterpart-type data, the combination of the corresponding types, and the like.

In addition, the detection unit 64 notifies, via the communication processing unit 51, a higher-order device inside or outside the target vehicle 1 that an unauthorized message is being transmitted in a bus 13.

[Operation Flow]

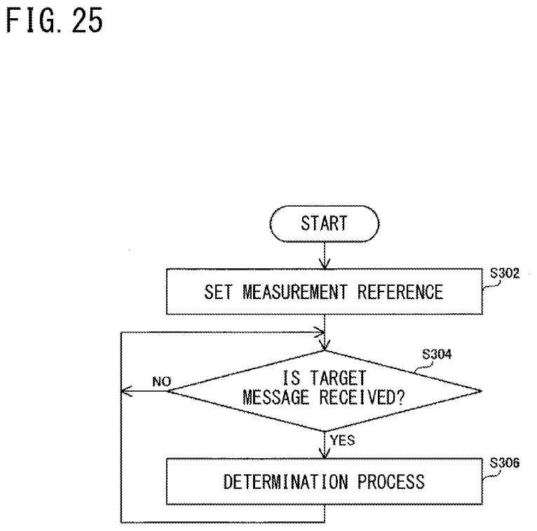

FIG. 25 is a flow chart of a procedure of operation performed when the gateway device according to the third embodiment of the present disclosure receives a target message.

With reference to FIG. 25, first, the gateway device 103 receives the first target message, and sets the reception time of the target message as a measurement reference (step S302).

Next, the gateway device 103 waits until receiving a target message (NO in step S304).

Then, upon receiving a target message (YES in step S304), the gateway device 103 performs a determination process of determining whether or not the received target message should be determined as an unauthorized message (step S306).

Next, the gateway device 103 waits until receiving a new target message (NO in step S306).

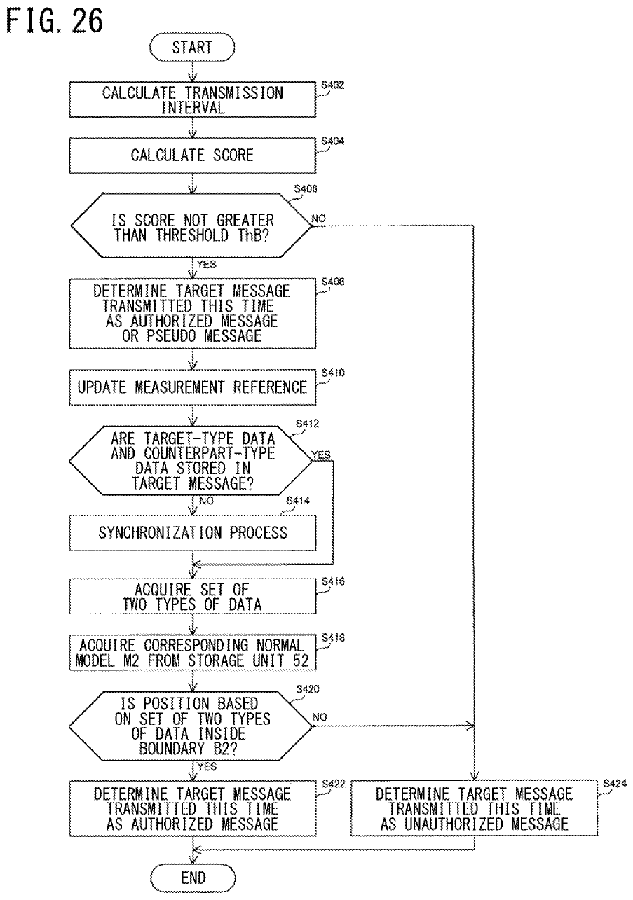

FIG. 26 is a flow chart of a procedure of operation performed when the gateway device according to the third embodiment of the present disclosure performs the determination process. FIG. 26 shows the details of the operation of step S306 in FIG. 25.

With reference to FIG. 26, the gateway device 103 calculates a transmission interval by subtracting the measurement reference from the reception time of the target message (step S402).

Next, the gateway device 103 calculates a score by substituting the calculated transmission interval into the score function Sc1 (step S404).

Next, when the calculated score is greater than the threshold ThB (NO in step S406), the gateway device 103 determines that the target message transmitted this time is an unauthorized message (step S424).

Meanwhile, when the calculated scores is not greater than the threshold ThB (YES in step S406), the gateway device 103 determines that the target message transmitted this time is an authorized message or a pseudo message (step S408).

Next, the gateway device 103 updates the measurement reference to the reception time of the target message transmitted this time (step S410).

Next, the gateway device 103 confirms whether or not both the target-type data and the counterpart-type data are stored in the target message (step S412).

Next, when both the target-type data and the counterpart-type data are not included in the target message, i.e. when the target-type data and the counterpart-type data are included in separate messages (NO in step S412), the gateway device 103 performs a synchronization process on the target-type data and the counterpart-type data (step S414).

Next, the gateway device 103 acquires a set of the two types of data, more specifically, a set of the target-type data and the counterpart-type data from the target message, or acquires the newest set of the target-type data and the counterpart-type data from the target-type data and the counterpart-type data which have been subjected to the synchronization process (step S416).

Next, the gateway device 103 acquires, from the storage unit 52, a normal model M2 that corresponds to the set of the target-type data and the counterpart-type data (step S418).

Next, the gateway device 103 confirms whether or not the position based on the acquired set of the target-type data and the counterpart-type data is inside the boundary B2 of the normal model M2 (step S420).

When the position based on the acquired set of the target-type data and the counterpart-type data is inside the boundary B2 (YES in step S420), the gateway device 103 determines that the target message transmitted this time is an authorized message (step S422).

Meanwhile, when the position based on the acquired set of the target-type data and the counterpart-type data is outside the boundary B2 (NO in step S420), the gateway device 103 determines that the target message transmitted this time is a pseudo message, i.e., an unauthorized message (step S424).

In the gateway device according to the third embodiment of the present disclosure, the monitor unit 57 measures a transmission interval on the basis of the reception time of the target message. However, the present disclosure is not limited thereto. For example, the monitor unit 57 may acquire the transmission time of the target message and measure a transmission interval on the basis of the acquired transmission time.

The gateway device according to the third embodiment of the present disclosure acquires a distribution of target message transmission interval measured in a test vehicle. However, the present disclosure is not limited thereto. The gateway device 103 may accumulate transmission intervals measured in the target vehicle 1 and may create the distribution on the basis of the accumulated transmission intervals.

As described above, in the gateway device according to the third embodiment of the present disclosure, the monitor unit 57 monitors transmission messages in the on-vehicle network 12. The distribution acquisition unit 58 acquires a distribution of transmission interval of transmission message. The detection unit 64 detects an unauthorized message on the basis of a monitoring result by the monitor unit 57 and the distribution acquired by the distribution acquisition unit 58. Then, with respect to a transmission message that has been determined as not to be classified as an unauthorized message, the detection unit 64 determines whether or not the transmission message is an unauthorized message, on the basis of the set acquired by the data acquisition unit 53 and the detection condition.

A transmission message that has a pseudo transmission interval accurately adjusted is difficult to be detected as an unauthorized message on the basis of the monitoring result and the distribution described above. Due to the above configuration, such a transmission message can be detected as an unauthorized message on the basis of the set and the detection condition described above. Therefore, security in the on-vehicle network 12 can be improved.

The other configurations and operations are the same as those of the gateway device according to the first embodiment. Thus, detailed description thereof is not repeated here.

It should be noted that part or all of the components and operations of the devices according to the first embodiment to the third embodiment of the present disclosure can be combined as appropriate.

The disclosed embodiments are merely illustrative in all aspects and should not be recognized as being restrictive. The scope of the present disclosure is defined by the scope of the claims rather than by the description above, and is intended to include meaning equivalent to the scope of the claims and all modifications within the scope.

The above description includes the features in the additional notes below.

[Additional Note 1]

A detection device configured to detect an unauthorized message in an on-vehicle network mounted in a vehicle, the detection device comprising:

a message acquisition unit configured to acquire one or a plurality of transmission messages in the on-vehicle network;

a data acquisition unit configured to acquire a set of a plurality of types of data that are included in the transmission messages acquired by the message acquisition unit and that correspond to the same time;

a storage unit configured to store a detection condition, the detection condition being created in advance and based on a plurality of the sets that respectively correspond to a plurality of times; and

a detection unit configured to detect the unauthorized message on the basis of the set acquired by the data acquisition unit and the detection condition, wherein

the detection device is a gateway device configured to relay each transmission message,

the on-vehicle network includes an on-vehicle device that is a device in the vehicle,

the on-vehicle device is an on-vehicle communication device configured to communicate with a device outside the vehicle provided with the on-vehicle network, or is a control device capable of controlling a function section in the vehicle,

the transmission message is transmitted in the on-vehicle network in accordance with a communication standard of CAN (Controller Area Network), FlexRay, MOST (Media Oriented Systems Transport), Ethernet, or LIN (Local Interconnect Network),

the detection condition is a normal model and is created in advance in a server, and

the time is a reception time, a transmission time, or a creation time.

### REFERENCE SIGNS LIST

1 target vehicle
12 on-vehicle network
13, 14 bus
51 communication processing unit
52 storage unit
53 data acquisition unit
54 detection unit
55 message acquisition unit
56 update unit
57 monitor unit
58 distribution acquisition unit
64 detection unit
101, 102, 103 gateway device (detection device)
111 on-vehicle communication device
112 port
121 bus connection device group
122 control device
301 on-vehicle communication system

1. A detection device configured to detect an unauthorized message in an on-vehicle network mounted in a vehicle, the detection device comprising:
a message acquisition unit configured to acquire one or a plurality of transmission messages in the on-vehicle network;
a data acquisition unit configured to acquire a set of a plurality of types of data that are included in the transmission messages acquired by the message acquisition unit and that correspond to the same time;
a storage unit configured to store a detection condition, the detection condition being created in advance and based on a plurality of the sets that respectively correspond to a plurality of times; and
a detection unit configured to detect the unauthorized message on the basis of the set acquired by the data acquisition unit and the detection condition.

2. The detection device according to claim 1, wherein
the detection condition is created on the basis of the sets of a plurality of types of data that have a predetermined correlation.

3. The detection device according to claim 2, wherein
when there are a plurality of types of correlation data that are the data having the correlation with a certain type of the data, the single detection condition is created on the basis of the certain type of the data and the plurality of types of the correlation data.

4. The detection device according to claim 3, wherein
the detection unit
calculates an estimated error of the certain type of the data on the basis of the certain type of the data and the plurality of types of the correlation data acquired by the data acquisition unit and the detection condition,
evaluates authenticity of the certain type of the data on the basis of the calculated estimated error and a distribution of the estimated error created by use of the detection condition, and
determines whether or not the certain type of the data is the unauthorized message, on the basis of a result of the evaluation.

5. The detection device according to claim 3, wherein
the certain type of the data is data that indicates a state, and
the detection unit
estimates a value of the certain type of the data on the basis of the plurality of types of the correlation data acquired by the data acquisition unit and the detection condition, and
determines whether or not the certain type of the data corresponds to the unauthorized message, on the basis of a result of comparison between the estimated value and the certain type of the data.

6. The detection device according to claim 2, wherein
when there are a plurality of types of correlation data that are the data having the correlation with a certain type of the data, a plurality of the detection conditions are created on the basis of the certain type of the data and the plurality of types of the correlation data, respectively.

7. The detection device according to claim 1, wherein
the data acquisition unit acquires a set of the plurality of types of data respectively included in the transmission messages that are different from each other.

8. The detection device according to claim 7, wherein
the message acquisition unit stores, into the storage unit, a plurality of the transmission messages having been acquired, and
the data acquisition unit acquires the set from the transmission messages stored in the storage unit.

9. The detection device according to claim 1, wherein
the detection device further includes
an update unit configured to update the detection condition on the basis of the set acquired by the data acquisition unit.

10. The detection device according to claim 1, wherein
the detection device further includes
a monitor unit configured to monitor the transmission messages in the on-vehicle network, and
a distribution acquisition unit configured to acquire a distribution of transmission intervals of the transmission messages,
the detection unit detects the unauthorized message on the basis of a monitoring result by the monitor unit and the distribution acquired by the distribution acquisition unit, and
with respect to a transmission message that has been determined as not to be classified as the unauthorized message, the detection unit determines whether or not the transmission message is the unauthorized message, on the basis of the set acquired by the data acquisition unit and the detection condition.

11. A detection method to be performed in a detection device, the detection device including a storage unit and configured to detect an unauthorized message in an on-vehicle network mounted in a vehicle, the detection method comprising:
a step of acquiring one or a plurality of transmission messages in the on-vehicle network; and
a step of acquiring a set of a plurality of types of data that are included in the acquired transmission messages and that correspond to the same time, wherein
the storage unit stores a detection condition created in advance and based on a plurality of the sets that respectively correspond to a plurality of times, and
the detection method further includes
a step of detecting the unauthorized message on the basis of the acquired set and the detection condition.

12. A non-transitory computer readable storage medium storing a detection program to be used in a detection device, the detection device including a storage unit and configured to detect an unauthorized message in an on-vehicle network mounted in a vehicle, the detection program configured to cause a computer to function as:
a message acquisition unit configured to acquire one or a plurality of transmission messages in the on-vehicle network; and
a data acquisition unit configured to acquire a set of a plurality of types of data that are included in the transmission messages acquired by the message acquisition unit and that correspond to the same time, wherein
the storage unit stores a detection condition created in advance and based on a plurality of the sets that respectively correspond to a plurality of times, and
the detection program further causes the computer to function as
a detection unit configured to detect the unauthorized message on the basis of the set acquired by the data acquisition unit and the detection condition.
